(19) United States
(12) Patent Application Publication
(10) Pub. No.: US 2025/0303734 A1
(43) Pub. Date: Oct. 2, 2025

(54) LIQUID EJECTION APPARATUS

(71) Applicant: SEIKO EPSON CORPORATION, Tokyo (JP)

(72) Inventors: Tomohiro KAWASAKI, SHIOJIRI-SHI (JP); Yuki HIRABAYASHI, SHIOJIRI-SHI (JP); Masaru KOBASHI, MATSUMOTO-SHI (JP)

(21) Appl. No.: 19/091,492

(22) Filed: Mar. 26, 2025

(30) Foreign Application Priority Data
Mar. 27, 2024 (JP) 2024-051312
Jun. 5, 2024 (JP) 2024-091544
Jun. 5, 2024 (JP) 2024-091545
Jun. 5, 2024 (JP) 2024-091546

(51) Int. Cl. B41J 2/18; B41J 2/175; B41J 2/20

(52) U.S. Cl. CPC B41J 2/18; B41J 2/17563; B41J 2/17596; B41J 2/20

(57) ABSTRACT

A liquid ejection apparatus includes a liquid ejection unit capable of ejecting a liquid, a circulation flow path for supplying the liquid to the liquid ejection unit and recover the liquid from the liquid ejection unit, a pressure change mechanism for changing pressure of the liquid in the circulation flow path, a pressure control valve disposed upstream of the liquid ejection unit in the circulation flow path and configured to adjust pressure of the liquid flowing into the liquid ejection unit, and a negative pressure control valve disposed downstream of the liquid ejection unit in the circulation flow path and for adjusting pressure of the liquid flowing out from the liquid ejection unit, wherein the circulation flow path includes a main flow path in which the pressure control valve and the negative pressure control valve are disposed, and a bypass flow path branched from the main flow path.

The present application is based on, and claims priority from JP Application Serial Number 2024-091546, filed Jun. 5, 2024, JP Application Serial Number 2024-051312, filed Mar. 27, 2024, JP Application Serial Number 2024-091545, filed Jun. 5, 2024, and JP Application Serial Number 2024-091544, filed Jun. 5, 2024, the disclosure of which are hereby incorporated by reference herein in their entirety.

### BACKGROUND

### 1. Technical Field

The present disclosure relates to a liquid ejection apparatus such as a printer.

### 2. Related Art

There is a printer as an example of a liquid ejection apparatus which ejects ink as an example of a liquid from a recording head as an example of a liquid ejection unit to thereby perform printing as described in, for example, JP-A-2012-86535. The printer includes a pressure control valve. The pressure control valve includes a valve chamber, a pressure chamber, an on-off valve, and an elastic partition wall.

The ink supplied from an ink cartridge is fed to the valve chamber. When the pressure in the pressure chamber decreases, the elastic partition wall deforms to open the on-off valve. When the on-off valve is opened, the ink flows from the valve chamber to the pressure chamber, and the ink is fed from the pressure chamber to the recording head.

JP-A-2012-86535 is an example of the related art.

Appropriate pressure of a liquid supplied to a liquid ejection unit may vary depending on a condition of a liquid ejection apparatus. However, the on-off valve in JP-A-2012-86535 supplies the ink at preset pressure to the recording head. Therefore, it is difficult to change the pressure of the ink supplied to the liquid ejection unit from the preset pressure.

### SUMMARY

A liquid ejection apparatus which solves the problem described above includes a liquid ejection unit configured to eject a liquid, a circulation flow path configured to supply the liquid to the liquid ejection unit and recover the liquid from the liquid ejection unit, a pressure change mechanism configured to change pressure of the liquid in the circulation flow path, a first pressure control valve disposed upstream of the liquid ejection unit in the circulation flow path and configured to adjust pressure of the liquid flowing into the liquid ejection unit, and a second pressure control valve disposed downstream of the liquid ejection unit in the circulation flow path and configured to adjust pressure of the liquid flowing out from the liquid ejection unit, wherein the circulation flow path includes a main flow path in which the first pressure control valve and the second pressure control valve are disposed, and a bypass flow path branched from the main flow path.

### BRIEF DESCRIPTION OF THE DRAWINGS

FIG. 1 is a schematic diagram of an embodiment of a liquid ejection apparatus.

FIG. 2 is a schematic cross-sectional view of a pressure control valve provided to the liquid ejection apparatus.

FIG. 3 is a schematic cross-sectional view of a negative pressure control valve provided to the liquid ejection apparatus.

FIG. 4 is a schematic cross-sectional view of a pressure release valve provided to the liquid ejection apparatus.

FIG. 5 is a schematic cross-sectional view of a negative pressure release valve provided to the liquid ejection apparatus.

FIG. 6 is a schematic diagram of a first modified example of the liquid ejection apparatus.

FIG. 7 is a schematic diagram of a second modified example of the liquid ejection apparatus.

FIG. 8 is a schematic diagram of a third modified example of the liquid ejection apparatus.

FIG. 9 is a schematic diagram of a fourth modified example of the liquid ejection apparatus.

FIG. 10 is a schematic diagram of a fifth modified example of the liquid ejection apparatus.

FIG. 11 is a schematic diagram of a sixth modified example of the liquid ejection apparatus.

FIG. 12 is a schematic diagram of a seventh modified example of the liquid ejection apparatus.

FIG. 13 is a schematic diagram of an eighth modified example of the liquid ejection apparatus.

FIG. 14 is a schematic diagram of a ninth modified example of the liquid ejection apparatus.

FIG. 15 is a schematic diagram of a tenth modified example of the liquid ejection apparatus.

### DESCRIPTION OF EMBODIMENTS

### Embodiment

An embodiment of a liquid ejection apparatus will hereinafter be described with reference to the drawings. The liquid ejection apparatus is, for example, an inkjet type printer that discharges ink as an example of a liquid onto a medium such as paper, fabric, vinyl, a plastic component, or a metal component to perform printing.

In the drawings, a direction of gravity is represented by a Z axis, and directions along a horizontal plane are represented by an X axis and a Y axis assuming that the liquid ejection apparatus 11 is placed on the horizontal plane. The X axis, the Y axis, and the Z axis are perpendicular to each other. In the following description, a direction parallel to the Z axis is also referred to as a vertical direction Z.

### Liquid Ejection Apparatus

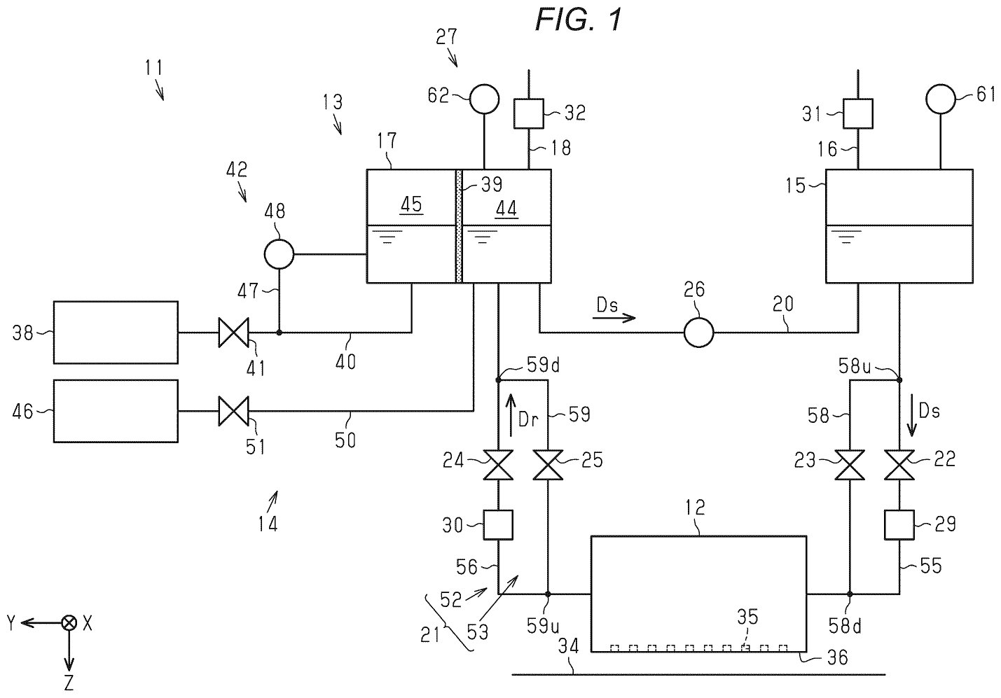

As illustrated in FIG. 1, the liquid ejection apparatus 11 may include a liquid ejection unit 12, a moisturizing unit 13, a supply unit 14, a first liquid storage unit 15, a first gas flow path 16, a second liquid storage unit 17, and a second gas flow path 18. The liquid ejection apparatus 11 may include a return flow path 20, a circulation flow path 21, a first upstream valve 22, a second upstream valve 23, a first downstream valve 24, a second downstream valve 25, a liquid pump 26, and a pressure change mechanism 27. The liquid ejection apparatus 11 may include a pressure control valve 29 as an example of a first pressure control valve, a negative pressure control valve 30 as an example of a second pressure control valve, a pressure release valve 31, and a negative pressure release valve 32.

The liquid ejection unit 12 is capable of ejecting a liquid. The liquid ejection unit 12 is configured to eject the liquid to a medium 34. The liquid ejection unit 12 has a nozzle surface 36 on which at least one nozzle 35 opens. The liquid ejection unit 12 ejects the liquid from the nozzle 35. The inside of the liquid ejection unit 12 is usually maintained at a negative pressure. This is for providing a meniscus to the nozzle 35. This makes it possible for the liquid ejection unit 12 to appropriately eject the liquid.

The moisturizing unit 13 keeps humidity of the liquid flowing through the circulation flow path 21 with a moisturizing liquid. The moisturizing unit 13 may cause the moisturizing liquid to flow. The moisturizing liquid is a liquid for keeping the humidity of the liquid. The moisturizing liquid is, for example, a water solution of glycerol.

The moisturizing unit 13 may be coupled to a moisture supply source 38. The moisture supply source 38 stores moisture, that is, water. The moisture supply source 38 may be a cartridge, a bag, or the like detachably attached to the liquid ejection apparatus 11, or may be a tank which can be replenished with the liquid.

The moisturizing unit 13 may include a moisture permeable film 39, a moisture supply flow path 40, a moisture supply valve 41, and a stirring unit 42.

The moisture permeable film 39 separates the liquid from the moisturizing liquid. The moisture permeable film 39 may be provided in the second liquid storage unit 17. The moisture permeable film 39 partitions the inside of the second liquid storage unit 17 into a liquid chamber 44 and a moisturizing liquid chamber 45. The liquid chamber 44 is capable of storing the liquid. The liquid is supplied from the liquid supply source 46 to the liquid chamber 44. The moisturizing liquid chamber 45 is capable of storing the moisturizing liquid. The moisturizing liquid chamber 45 is supplied with moisture from the moisture supply source 38.

The moisture permeable film 39 is a film that transmits a gas but does not transmit a liquid. Therefore, the moisture permeable film 39 separates the liquid stored in the liquid chamber 44 and the moisturizing liquid stored in the moisturizing liquid chamber 45 so that the liquid and the moisturizing liquid are not mixed. The moisture permeable film 39 is a porous film provided with a plurality of fine pores. In the fine pores, a meniscus is generated by the surface tension of the liquid. Accordingly, the moisture permeable film 39 transmits the gas but does not transmit the liquid. The moisturizing liquid moisturizes the liquid by supplying moisture to the liquid through the moisture permeable film 39.

The moisture supply flow path 40 couples the moisture supply source 38 and the moisturizing liquid chamber 45.

The moisture supply valve 41 is located in the moisture supply flow path 40. When the moisture supply valve 41 is opened, it becomes possible to supply moisture from the moisture supply source 38 to the second liquid storage unit 17. Normally, the moisture supply valve 41 is closed. The moisture supply valve 41 is opened when it is necessary to supply moisture to the second liquid storage unit 17.

The stirring unit 42 is attached to the second liquid storage unit 17. The stirring unit 42 stirs the moisturizing liquid stored in the moisturizing liquid chamber 45. As the stirring unit 42 stirs the moisturizing liquid, the concentration of the moisturizing liquid is made uniform. This reduces the possibility that the concentration of the moisturizing liquid increases.

The stirring unit 42 may include a stirring flow path 47 and a stirring pump 48. The stirring flow path 47 is coupled to the moisturizing liquid chamber 45 and the moisture supply flow path 40. The stirring pump 48 is located in the stirring flow path 47. The stirring pump 48 circulates the moisturizing liquid in the second liquid storage unit 17 through the stirring flow path 47. Thus, the moisturizing liquid is stirred.

The supply unit 14 may include a liquid supply flow path 50 and a liquid supply valve 51.

The liquid supply flow path 50 is coupled to the liquid supply source 46 and the liquid chamber 44. The liquid supply source 46 stores the liquid. The liquid supply source 46 may be a cartridge, a bag, or the like detachably attachable to the liquid ejection apparatus 11, or may be a tank which can be replenished with the liquid.

The liquid supply valve 51 is located in the liquid supply flow path 50. When the liquid supply valve 51 is opened, it becomes possible to supply the liquid from the liquid supply source 46 to the second liquid storage unit 17. Normally, the liquid supply valve 51 is closed. The liquid supply valve 51 is opened when it is necessary to supply the liquid to the second liquid storage unit 17.

The first liquid storage unit 15 can store the liquid supplied to the liquid ejection unit 12.

The first gas flow path 16 is coupled to the first liquid storage unit 15. One end of the first gas flow path 16 is coupled to the first liquid storage unit 15, and the other end thereof is opened to the atmosphere. The first gas flow path 16 may be provided with the pressure release valve 31. The pressure release valve 31 may be coupled to the first liquid storage unit 15 via the first gas flow path 16. The pressure release valve 31 can adjust the pressure of the first liquid storage unit 15.

The second liquid storage unit 17 can store the liquid recovered from the liquid ejection unit 12.

The second gas flow path 18 is coupled to the second liquid storage unit 17. One end of the second gas flow path 18 is coupled to the liquid chamber 44, and the other end is opened to the atmosphere, for example. The negative pressure release valve 32 may be disposed in the second gas flow path 18. The negative pressure release valve 32 may be coupled to the second liquid storage unit 17 via the second gas flow path 18. The negative pressure release valve 32 can adjust the pressure of the second liquid storage unit 17.

The return flow path 20 couples the first liquid storage unit 15 and the second liquid storage unit 17 to each other. An upstream end in a supply direction Ds of the return flow path 20 is coupled to the second liquid storage unit 17. A downstream end in the supply direction Ds of the return flow path 20 is coupled to the first liquid storage unit 15.

The circulation flow path 21 includes a main flow path 52 and a bypass flow path 53. The main flow path 52 couples the first liquid storage unit 15 and the second liquid storage unit 17 to each other. An upstream end of the main flow path 52 is coupled to the first liquid storage unit 15. A downstream end of the main flow path 52 is coupled to the second liquid storage unit 17. The main flow path 52 may include a supply flow path 55 and a recovery flow path 56. The bypass flow path 53 branches from the main flow path 52. The bypass flow path 53 may include a first bypass flow path 58 and a second bypass flow path 59.

The circulation flow path 21 supplies the liquid to the liquid ejection unit 12. The circulation flow path 21 recovers the liquid from the liquid ejection unit 12. The liquid ejection unit 12 is disposed in the circulation flow path 21. The circulation flow path 21 circulates the liquid together with the return flow path 20. When the liquid is circulated, the liquid flows from the second liquid storage unit 17 to the first liquid storage unit 15 through the return flow path 20. When the liquid is circulated, the liquid flows from the first liquid storage unit 15 to the liquid ejection unit 12 through the supply flow path 55. When the liquid is circulated, the liquid flows from the liquid ejection unit 12 to the second liquid storage unit 17 through the recovery flow path 56.

The supply flow path 55 is coupled to the first liquid storage unit 15. An upstream end in the supply direction Ds of the supply flow path 55 is coupled to the first liquid storage unit 15. A downstream end in the supply direction Ds of the supply flow path 55 is coupled to the liquid ejection unit 12. The supply flow path 55 supplies the liquid to the liquid ejection unit 12. The first liquid storage unit 15 and the liquid ejection unit 12 communicate with each other with the supply flow path 55. Two things communicating with each other are coupled to each other in a state in which a fluid such as a liquid or a gas can flow. The supply flow path 55 couples the first liquid storage unit 15 and the liquid ejection unit 12 to each other in a state in which the liquid can flow. The supply flow path 55 feeds the liquid flowing out from the first liquid storage unit 15 to the liquid ejection unit 12.

The first upstream valve 22 and the pressure control valve 29 are disposed in the supply flow path 55. The first upstream valve 22 and the pressure control valve 29 are disposed upstream of the liquid ejection unit 12 in the circulation flow path 21. The first upstream valve 22 can open and close the supply flow path 55. The pressure control valve 29 is disposed between the first upstream valve 22 and the liquid ejection unit 12. The pressure control valve 29 controls the pressure of the liquid flowing into the liquid ejection unit 12.

The recovery flow path 56 is coupled to the second liquid storage unit 17. A downstream end in a recovery direction Dr of the recovery flow path 56 is coupled to the second liquid storage unit 17. An upstream end in the recovery direction Dr of the recovery flow path 56 is coupled to the liquid ejection unit 12. The liquid ejection unit 12 and the second liquid storage unit 17 communicate with each other with the recovery flow path 56. The recovery flow path 56 couples the liquid ejection unit 12 and the second liquid storage unit 17 to each other in a state in which the liquid can flow. The recovery flow path 56 recovers the liquid from the liquid ejection unit 12. The recovery flow path 56 feeds the liquid recovered from the liquid ejection unit 12 to the second liquid storage unit 17.

The first downstream valve 24 and the negative pressure control valve 30 are disposed in the recovery flow path 56. The first downstream valve 24 and the negative pressure control valve 30 are disposed downstream in the recovery direction Dr of the liquid ejection unit 12 in the circulation flow path 21. The first downstream valve 24 can open and close the recovery flow path 56. The negative pressure control valve 30 is disposed between the liquid ejection unit 12 and the first downstream valve 24. The negative pressure control valve 30 controls the pressure of the liquid which flows out from the liquid ejection unit 12. The negative pressure control valve 30 controls the negative pressure at the liquid ejection unit 12 side. The negative pressure control valve 30 makes a level of the negative pressure at the liquid ejection unit 12 side smaller than a level of the negative pressure at the second liquid storage unit 17 side.

The first bypass flow path 58 may branch from the supply flow path 55 and merge with the supply flow path 55. The first bypass flow path 58 may be disposed in parallel to the supply flow path 55. A first upstream end 58u of the first bypass flow path 58 may be located upstream in the supply direction Ds of the pressure control valve 29. The first upstream end 58u may be located between the first liquid storage unit 15 and the first upstream valve 22. A first downstream end 58d of the first bypass flow path 58 may be located downstream of the pressure control valve 29. The first downstream end 58d may be located between the pressure control valve 29 and the liquid ejection unit 12. The second upstream valve 23 is disposed in the first bypass flow path 58. The second upstream valve 23 can open and close the first bypass flow path 58.

The second bypass flow path 59 may branch from the recovery flow path 56 and merge with the recovery flow path 56. The second bypass flow path 59 may be disposed in parallel to the recovery flow path 56. The second upstream end 59u of the second bypass flow path 59 may be located upstream in the recovery direction Dr of the negative pressure control valve 30. The second upstream end 59u may be located between the liquid ejection unit 12 and the negative pressure control valve 30. The second downstream end 59d of the second bypass flow path 59 may be located downstream of the negative pressure control valve 30. The second downstream end 59d may be located between the first downstream valve 24 and the second liquid storage unit 17. The second downstream valve 25 is disposed in the second bypass flow path 59. The second downstream valve 25 is capable of opening and closing the second bypass flow path 59.

The liquid pump 26 is disposed in the return flow path 20. The liquid pump 26 feeds the liquid from the second liquid storage unit 17 to the first liquid storage unit 15 via the return flow path 20.

The pressure change mechanism 27 changes the pressure of the liquid in the circulation flow path 21. The pressure change mechanism 27 may include a pressure pump 61 and a pressure reducing pump 62.

The pressure pump 61 pressurizes the inside of the first liquid storage unit 15. The pressure pump 61 changes the pressure of the liquid flowing through the supply flow path 55. The pressure pump 61 may pressurize the inside of the first liquid storage unit 15 by feeding air into the first liquid storage unit 15. When the pressure pump 61 pressurizes the inside of the first liquid storage unit 15, the liquid in the first liquid storage unit 15 flows out to the supply flow path 55. When the pressure in the first liquid storage unit 15 exceeds a predetermined pressure, the pressure release valve 31 is opened to release the pressure in the first liquid storage unit 15.

The pressure reducing pump 62 reduces the pressure in the second liquid storage unit 17. For example, the pressure reducing pump 62 may reduce the pressure in the second liquid storage unit 17 by drawing air from the inside of the second liquid storage unit 17. The pressure reducing pump 62 normally reduces the pressure in the second liquid storage unit 17 so that the inside of the liquid ejection unit 12 is maintained at a predetermined negative pressure.

When the pressure reducing pump 62 reduces the pressure in the second liquid storage unit 17, the liquid flows into the second liquid storage unit 17. For example, when the pressure reducing pump 62 is driven in a state where the liquid supply valve 51 is opened, the liquid flows into the second liquid storage unit 17 from the liquid supply source 46 through the liquid supply flow path 50. When the pressure reducing pump 62 is driven in a state where the moisture supply valve 41 is opened, the liquid flows into the second liquid storage unit 17 from the moisture supply source 38 through the moisture supply flow path 40. When the pressure reducing pump 62 is driven in a state where the liquid supply valve 51 and the moisture supply valve 41 are closed and at least one of the first downstream valve 24 and the second downstream valve 25 is opened, the liquid flows into the second liquid storage unit 17 from the liquid ejection unit 12 through the recovery flow path 56.

### Pressure Control Valve

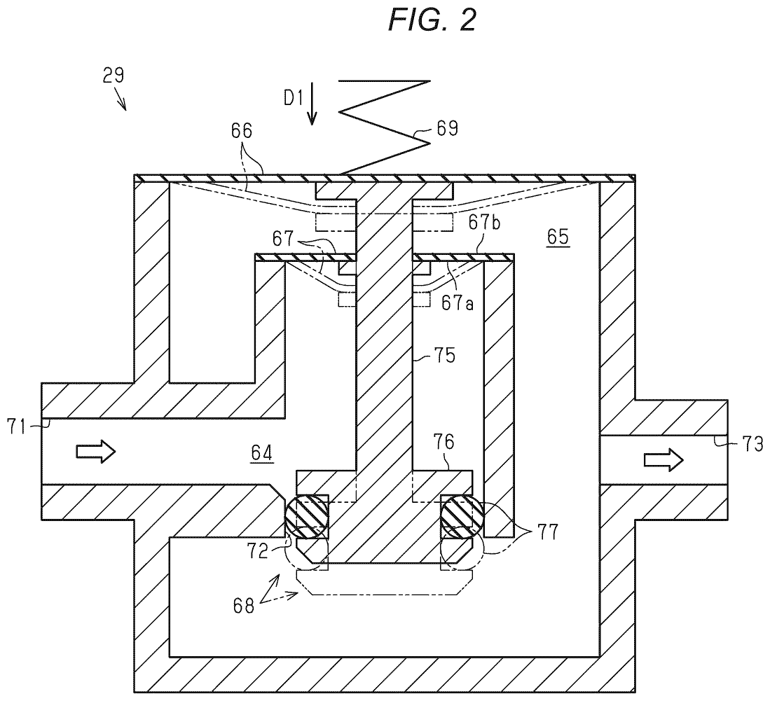

As shown in FIG. 2, the pressure control valve 29 includes a first upstream chamber 64 and a first downstream chamber 65. The first downstream chamber 65 includes a first flexible film 66. The pressure control valve 29 includes a second flexible film 67, a first opening and closing part 68, and a first biasing part 69. The first opening and closing part 68 is movable between a close position indicated by a solid line in FIG. 2 and an open position indicated by a two-dot chain line in FIG. 2. In the present embodiment, a state where the first opening and closing part 68 is located at the close position is also referred to as a close state, and a state where the first opening and closing part 68 is located at the open position is also referred to as an open state. In FIG. 2, the direction in which a fluid flows is indicated by an outlined arrow.

The first upstream chamber 64 has a first inflow port 71. The first inflow port 71 in the present embodiment communicates with the first liquid storage unit 15 via the supply flow path 55. A fluid flows into the first upstream chamber 64 via the first inflow port 71. The fluid handled by the pressure control valve 29 in the present embodiment is a liquid.

The first downstream chamber 65 is disposed downstream of the first upstream chamber 64. The first downstream chamber 65 communicates with the first upstream chamber 64 downstream of the first upstream chamber 64 via a first communication opening 72. The first downstream chamber 65 has a first outflow port 73 through which a fluid flows out. The first outflow port 73 in the present embodiment communicates with the liquid ejection unit 12 via the supply flow path 55.

The first flexible film 66 forms a part of a wall of the first downstream chamber 65. The first flexible film 66 is formed of a flexible member having flexibility such as a diaphragm. The first flexible film 66 is displaced in accordance with a difference in pressure applied to an outer surface and an inner surface. A sum of the atmospheric pressure and force applied by the first biasing part 69 is applied to the outer surface of the first flexible film 66. The pressure of the fluid in the first downstream chamber 65 is applied to the inner surface of the first flexible film 66. The first flexible film 66 in the close state indicated by the solid line in FIG. 2 is small in deflection. In the close state, the first flexible film 66 is preferably in a flat state with no deflection. In the close state, the first flexible film 66 may be in a state having a slight deflection. The deflection amount of the first flexible film 66 when the first opening and closing part 68 is in the close state indicated by the solid line in FIG. 2 may be smaller than the deflection amount of the first flexible film 66 when the first opening and closing part 68 is in the open state indicated by the two-dot chain line in FIG. 2.

The second flexible film 67 separates the first upstream chamber 64 from the first downstream chamber 65. The second flexible film 67 may be located on the first communication opening 72. The second flexible film 67 is located between the first communication opening 72 and the first flexible film 66. The first biasing part 69, the first flexible film 66, the second flexible film 67, and the first communication opening 72 may be arranged in this order in a first direction D1. The first direction D1 may be the same direction as the vertical direction Z.

The second flexible film 67 is displaced in accordance with a difference in pressure applied to a first surface 67a and a second surface 67b. The pressure of the fluid in the first upstream chamber 64 is applied to the first surface 67a. The pressure of the fluid in the first downstream chamber 65 is applied to the second surface 67b. In the close state, the second flexible film 67 is preferably in a flat state with no deflection. In the close state, the second flexible film 67 may be in a state having a slight deflection. The deflection amount of the second flexible film 67 when the first opening and closing part 68 is in the close state indicated by the solid line in FIG. 2 may be smaller than the deflection amount of the second flexible film 67 when the first opening and closing part 68 is in the open state indicated by the two-dot chain line in FIG. 2.

The first opening and closing part 68 may include a first shaft portion 75 and a first valve portion 76. The first valve portion 76 may include a first seal portion 77. The first opening and closing part 68 can open and close the first communication opening 72.

The first shaft portion 75 is disposed over the first upstream chamber 64 and the first downstream chamber 65. The first shaft portion 75 is inserted into the second flexible film 67. A longitudinal direction of the first shaft portion 75 may be parallel to the first direction D1. The first shaft portion 75 may have a rod shape. The first shaft portion 75 may have a columnar shape. A diameter of the first shaft portion 75 is smaller than an inner diameter of the first communication opening 72.

The first shaft portion 75 can move so as to follow a displacement of the first flexible film 66 and the second flexible film 67. The first shaft portion 75 is fixed to the first flexible film 66 and the second flexible film 67 directly or via a fixation member. One end of the first shaft portion 75 is coupled to the first flexible film 66. The other end of the first shaft portion 75 is coupled to the first valve portion 76. The first shaft portion 75 moves following the displacement of the first flexible film 66 to thereby displace the second flexible film 67 and the first valve portion 76.

The first valve portion 76 is coupled to the first shaft portion 75. The first valve portion 76 can open and close the first communication opening 72. The first valve portion 76 can restrict the flow of the fluid from the first upstream chamber 64 toward the first downstream chamber 65. The first valve portion 76 also moves together with the first shaft portion 75. When the first opening and closing part 68 is at the close position indicated by the solid line in FIG. 2, the first valve portion 76 makes the first upstream chamber 64 and the first downstream chamber 65 fail to communicate with each other. When the first opening and closing part 68 is at the open position indicated by the two-dot chain line in FIG. 2, the first valve portion 76 makes the first upstream chamber 64 and the first downstream chamber 65 communicate with each other.

The first seal portion 77 can adhere to the first communication opening 72. The first seal portion 77 forms an outer circumference of the first valve portion 76. The first seal portion 77 may have an annular shape. The first seal portion 77 may be an O-ring having a torus shape.

The first biasing part 69 biases the first flexible film 66 in the first direction D1 of decreasing a volume of the first downstream chamber 65. The first biasing part 69 is disposed outside the first downstream chamber 65. The first biasing part 69 presses the first opening and closing part 68 via the first flexible film 66. The first biasing part 69 is, for example, a compression spring.

### Operation of Pressure Control Valve

The pressure control valve 29 reduces the pressure of the fluid flowing into the first upstream chamber 64 to make the fluid flow out from the first downstream chamber 65. The pressure of the fluid flowing out from the first downstream chamber 65 is positive pressure. The pressure of the fluid flowing into the first upstream chamber 64 is positive pressure higher than the pressure of the fluid flowing out from the first downstream chamber 65.

The first opening and closing part 68 moves in accordance with a change in the pressure in the first downstream chamber 65. When the positive pressure in the first downstream chamber 65 decreases, the first flexible film 66 is displaced in a direction of decreasing the volume of the first downstream chamber 65 due to the biasing force of the first biasing part 69. The first opening and closing part 68 is pushed by the first flexible film 66 to move. The second flexible film 67 is displaced in sync with the first opening and closing part 68. The second flexible film 67 is displaced in a direction of decreasing the volume of the first upstream chamber 64 and increasing the volume of the first downstream chamber 65. The second flexible film 67 reduces the volume change of the first downstream chamber 65 due to the displacement of the first flexible film 66.

The first opening and closing part 68 is pushed by the first flexible film 66 to move to the open position. Therefore, the first upstream chamber 64 communicates with the first downstream chamber 65. The fluid is supplied from the first upstream chamber 64 to the first downstream chamber 65.

When the positive pressure in the first downstream chamber 65 increases, the first flexible film 66 is pushed by the fluid in the first downstream chamber 65 and is displaced in a direction of increasing the volume of the first downstream chamber 65. The first opening and closing part 68 and the second flexible film 67 move to the close position together with the first flexible film 66. Therefore, the supply of the fluid from the first upstream chamber 64 to the first downstream chamber 65 is stopped.

In the first upstream chamber 64, the pressure receiving area of the first valve portion 76 may be the same as the pressure receiving area of the second flexible film 67. The area of the first valve portion 76 in contact with the fluid in the first upstream chamber 64 may be substantially the same as the area of the second flexible film 67 in contact with the fluid in the first upstream chamber 64. In this case, even when the pressure in the first upstream chamber 64 increases, the first opening and closing part 68 does not move from the close position.

### Negative Pressure Control Valve

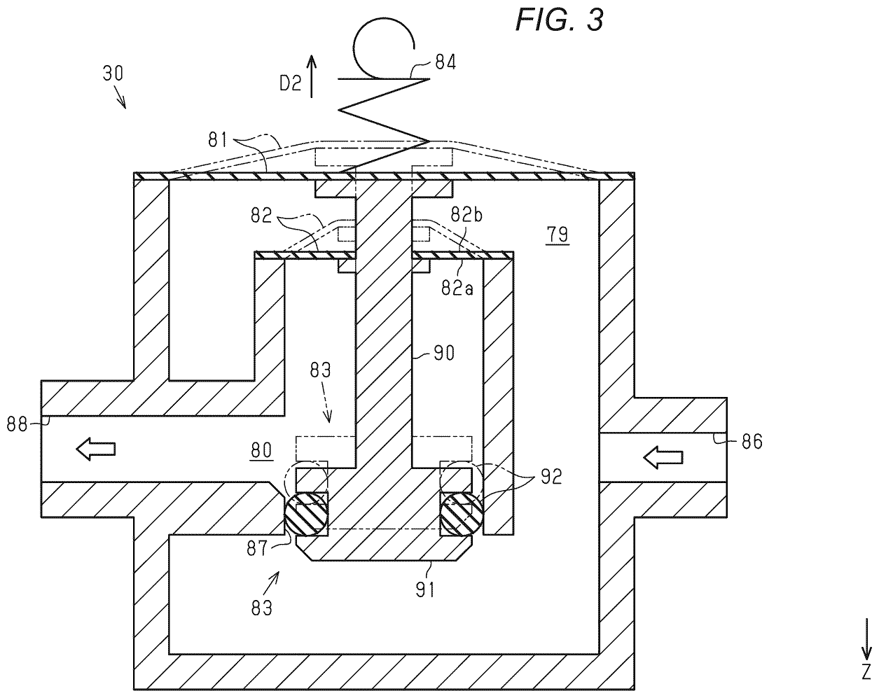

As shown in FIG. 3, the negative pressure control valve 30 includes a second upstream chamber 79 and a second downstream chamber 80. The second upstream chamber 79 has a third flexible film 81. The negative pressure control valve 30 includes a fourth flexible film 82, a second opening and closing part 83, and a second biasing part 84. The second opening and closing part 83 is movable between a close position indicated by a solid line in FIG. 3 and an open position indicated by a two-dot chain line in FIG. 3. In the present embodiment, a state where the second opening and closing part 83 is located at the close position is also referred to as a close state, and a state where the second opening and closing part 83 is located at the open position is also referred to as an open state.

The second upstream chamber 79 has a second inflow port 86 into which the fluid flows. The second inflow port 86 in the present embodiment is coupled to the liquid ejection unit 12 via the recovery flow path 56. The fluid flows into the second upstream chamber 79 via the second inflow port 86. The fluid handled by the negative pressure control valve 30 in the present embodiment is a liquid.

The second downstream chamber 80 is disposed downstream of the second upstream chamber 79. The second downstream chamber 80 communicates with the second upstream chamber 79 downstream of the second upstream chamber 79 via a second communication opening 87. The second downstream chamber 80 has a second outflow port 88 through which the fluid flows out. The second outflow port 88 in the present embodiment communicates with the second liquid storage unit 17 via the recovery flow path 56.

The third flexible film 81 forms a part of a wall of the second upstream chamber 79. The third flexible film 81 is formed of a flexible member having flexibility such as a diaphragm. The third flexible film 81 is displaced in accordance with a difference in pressure applied to an outer surface and an inner surface. Differential pressure between the atmospheric pressure and the biasing force of the second biasing part 84 is applied to the outer surface of the third flexible film 81. The pressure of the fluid in the second upstream chamber 79 is applied to the inner surface of the third flexible film 81. The third flexible film 81 in the close state indicated by the solid line in FIG. 3 is small in deflection. In the close state, the third flexible film 81 is preferably in a flat state with no deflection. In the close state, the third flexible film 81 may be in a state having a slight deflection. The deflection amount of the third flexible film 81 when the second opening and closing part 83 is in the close state indicated by the solid line in FIG. 3 may be smaller than the deflection amount of the third flexible film 81 when the second opening and closing part 83 is in the open state indicated by the two-dot chain line in FIG. 3.

The fourth flexible film 82 separates the second upstream chamber 79 from the second downstream chamber 80. The fourth flexible film 82 may be located on the second communication opening 87. The fourth flexible film 82 is located between the second communication opening 87 and the third flexible film 81. The second communication opening 87, the fourth flexible film 82, the third flexible film 81, and the second biasing part 84 may be arranged in this order in a second direction D2. The second direction D2 may be a direction opposite to the vertical direction Z.

The fourth flexible film 82 is displaced in accordance with a difference in pressure applied to a third surface 82a and a fourth surface 82b. The pressure of the fluid in the second downstream chamber 80 is applied to the third surface 82a. The pressure of the fluid in the second upstream chamber 79 is applied to the fourth surface 82b. In the close state, the fourth flexible film 82 is preferably in a flat state with no deflection. In the close state, the fourth flexible film 82 may be in a state having a slight deflection. The deflection amount of the fourth flexible film 82 when the second opening and closing part 83 is in the close state indicated by the solid line in FIG. 3 may be smaller than the deflection amount of the fourth flexible film 82 when the second opening and closing part 83 is in the open state indicated by the two-dot chain line in FIG. 3.

The second opening and closing part 83 may include a second shaft portion 90 and a second valve portion 91. The second valve portion 91 may include a second seal portion 92. The second opening and closing part 83 can open and close the second communication opening 87.

The second shaft portion 90 is disposed over the second upstream chamber 79 and the second downstream chamber 80. The second shaft portion 90 is inserted into the fourth flexible film 82. A longitudinal direction of the second shaft portion 90 may be parallel to the second direction D2. The second shaft portion 90 may have a rod shape. The second shaft portion 90 may have a columnar shape. A diameter of the second shaft portion 90 is smaller than an inner diameter of the second communication opening 87.

The second shaft portion 90 can move so as to follow a displacement of the third flexible film 81 and the fourth flexible film 82. The second shaft portion 90 is fixed to the third flexible film 81 and the fourth flexible film 82 directly or via a fixation member. One end of the second shaft portion 90 is coupled to the third flexible film 81. The other end of the second shaft portion 90 is coupled to the second valve portion 91. The second shaft portion 90 moves so as to follow the displacement of the third flexible film 81 to thereby displace the fourth flexible film 82 and the second valve portion 91.

The second valve portion 91 is coupled to the second shaft portion 90. The second valve portion 91 can open and close the second communication opening 87. The second valve portion 91 can restrict the flow of the fluid from the second upstream chamber 79 toward the second downstream chamber 80. The second valve portion 91 moves together with the second shaft portion 90. When the second opening and closing part 83 is at the close position indicated by the solid line in FIG. 3, the second valve portion 91 makes the second upstream chamber 79 and the second downstream chamber 80 fail to communicate with each other. When the second opening and closing part 83 is at the open position indicated by the two-dot chain line in FIG. 3, the second valve portion 91 makes the second upstream chamber 79 and the second downstream chamber 80 communicate with each other.

The second seal portion 92 can adhere to the second communication opening 87. The second seal portion 92 forms an outer circumference of the second valve portion 91. The second seal portion 92 may have an annular shape. The second seal portion 92 may be an O-ring having a torus shape.

The second biasing part 84 biases the third flexible film 81 in the second direction D2 of increasing the volume of the second upstream chamber 79. The second biasing part 84 is disposed outside the second upstream chamber 79. The second biasing part 84 pulls the second opening and closing part 83 via the third flexible film 81. The second biasing part 84 is, for example, a tension spring.

### Operation of Negative Pressure Control Valve

The negative pressure control valve 30 reduces the negative pressure of the fluid which acts on the second downstream chamber 80 to make the fluid act on the second upstream chamber 79. The pressure of the fluid flowing into the second upstream chamber 79 is negative pressure. The pressure of the fluid flowing out from the second downstream chamber 80 is a negative pressure lower than the pressure of the fluid flowing into the second upstream chamber 79.

The second opening and closing part 83 moves in accordance with a change in the pressure in the second upstream chamber 79. When the negative pressure in the second upstream chamber 79 decreases, the third flexible film 81 is displaced in a direction of increasing the volume of the second upstream chamber 79 due to the biasing force of the second biasing part 84. The second opening and closing part 83 is pulled by the third flexible film 81 to move. The fourth flexible film 82 is displaced in sync with the second opening and closing part 83. The fourth flexible film 82 is displaced in a direction of decreasing the volume of the second upstream chamber 79 and increasing the volume of the second downstream chamber 80. The fourth flexible film 82 reduces the volume change of the second upstream chamber 79 due to the displacement of the third flexible film 81.

The second opening and closing part 83 is pulled by the third flexible film 81 to move to the open position. Therefore, the second upstream chamber 79 communicates with the second downstream chamber 80. The fluid flows out from the second upstream chamber 79 to the second downstream chamber 80.

When the negative pressure in the second upstream chamber 79 increases, the third flexible film 81 is displaced in a direction of decreasing the volume of the second upstream chamber 79 in the teeth of the biasing force of the second biasing part 84. The second opening and closing part 83 and the fourth flexible film 82 move to the close position together with the third flexible film 81. Therefore, the outflow of the fluid from the second upstream chamber 79 to the second downstream chamber 80 is stopped.

In the second downstream chamber 80, the pressure receiving area of the second valve portion 91 may be the same as the pressure receiving area of the fourth flexible film 82. The area of the second valve portion 91 in contact with the fluid in the second downstream chamber 80 may be substantially the same as the area of the fourth flexible film 82 in contact with the fluid in the second downstream chamber 80. In this case, even when the pressure in the second downstream chamber 80 changes, the second opening and closing part 83 does not move from the close position.

### Pressure Release Valve

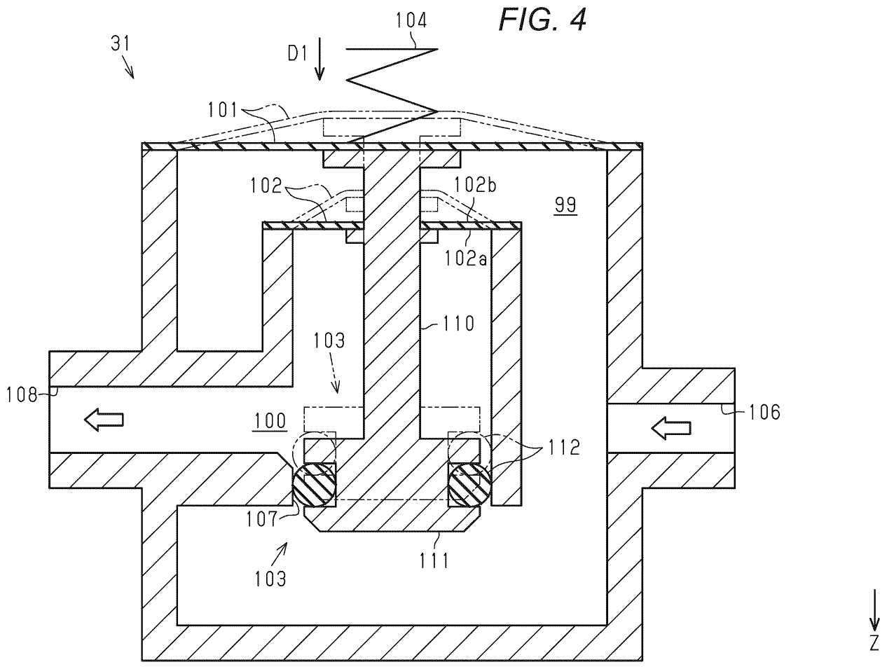

As shown in FIG. 4, the pressure release valve 31 includes a third upstream chamber 99 and a third downstream chamber 100. The third upstream chamber 99 includes a fifth flexible film 101. The pressure release valve 31 includes a sixth flexible film 102, a third opening and closing part 103, and a third biasing part 104. The third opening and closing part 103 can move to a close position indicated by a solid line in FIG. 4 and an open position indicated by a two-dot chain line in FIG. 4. In the present embodiment, a state in which the third opening and closing part 103 is located at the close position is also referred to as a close state, and a state in which the third opening and closing part 103 is located at the open position is also referred to as an open state.

The third upstream chamber 99 has a third inflow port 106 into which the fluid flows. The third inflow port 106 in the present embodiment is coupled to the first liquid storage unit 15 via the first gas flow path 16. The fluid flows into the third upstream chamber 99 via the third inflow port 106. The fluid handled by the pressure release valve 31 in the present embodiment is a gas.

The third downstream chamber 100 is disposed downstream of the third upstream chamber 99. The third downstream chamber 100 communicates with the third upstream chamber 99 downstream of the third upstream chamber 99 via a third communication opening 107. The third downstream chamber 100 has a third outflow port 108 through which the fluid flows out. The third outflow port 108 of the present embodiment communicates with the atmosphere via the first gas flow path 16. The third outflow port 108 may be directly opened to the atmosphere.

The fifth flexible film 101 forms a part of a wall of the third upstream chamber 99. The fifth flexible film 101 is formed by a flexible member having flexibility such as a diaphragm. The fifth flexible film 101 is displaced in accordance with a difference in pressure applied to an outer surface and an inner surface. A sum of the atmospheric pressure and the force applied by the third biasing part 104 is applied to the outer surface of the fifth flexible film 101. The pressure of the fluid in the third upstream chamber 99 is applied to the inner surface of the fifth flexible film 101. The fifth flexible film 101 in the close state indicated by the solid line in FIG. 4 is small in deflection. In the close state, the fifth flexible film 101 is preferably in a flat state with no deflection. In the close state, the fifth flexible film 101 may be in a state having a slight deflection. The deflection amount of the fifth flexible film 101 when the third opening and closing part 103 is in the close state indicated by the solid line in FIG. 4 may be smaller than the deflection amount of the fifth flexible film 101 when the third opening and closing part 103 is in the open state indicated by the two-dot chain line in FIG. 4.

The sixth flexible film 102 separates the third upstream chamber 99 from the third downstream chamber 100. The sixth flexible film 102 may be located on the third communication opening 107. The sixth flexible film 102 is located between the third communication opening 107 and the fifth flexible film 101. The third biasing part 104, the fifth flexible film 101, the sixth flexible film 102, and the third communication opening 107 may be arranged in this order in the first direction D1.

The sixth flexible film 102 is displaced in accordance with a difference in pressure applied to a fifth surface 102a and a sixth surface 102b. The pressure of the fluid in the third downstream chamber 100 is applied to the fifth surface 102a. The pressure of the fluid in the third upstream chamber 99 is applied to the sixth surface 102b. In the close state, the sixth flexible film 102 is preferably in a flat state with no deflection. In the close state, the sixth flexible film 102 may be in a state having a slight deflection. The deflection amount of the sixth flexible film 102 when the third opening and closing part 103 is in the close state indicated by the solid line in FIG. 4 may be smaller than the deflection amount of the sixth flexible film 102 when the third opening and closing part 103 is in the open state indicated by the two-dot chain line in FIG. 4.

The third opening and closing part 103 may include a third shaft portion 110 and a third valve portion 111. The third valve portion 111 may include a third seal portion 112. The third opening and closing part 103 can open and close the third communication opening 107.

The third shaft portion 110 is disposed over the third upstream chamber 99 and the third downstream chamber 100. The third shaft portion 110 is inserted into the sixth flexible film 102. A longitudinal direction of the third shaft portion 110 may be parallel to the first direction D1. The third shaft portion 110 may have a rod shape. The third shaft portion 110 may have a columnar shape. A diameter of the third shaft portion 110 is smaller than an inner diameter of the third communication opening 107.

The third shaft portion 110 can move so as to follow the displacement of the fifth flexible film 101 and the sixth flexible film 102. The third shaft portion 110 is fixed to the fifth flexible film 101 and the sixth flexible film 102 directly or via a fixation member. One end of the third shaft portion 110 is coupled to the fifth flexible film 101. The other end of the third shaft portion 110 is coupled to the third valve portion 111. The third shaft portion 110 moves so as to follow the displacement of the fifth flexible film 101 to thereby displace the sixth flexible film 102 and the third valve portion 111.

The third valve portion 111 is coupled to the third shaft portion 110. The third valve portion 111 can open and close the third communication opening 107. The third valve portion 111 can restrict the flow of the fluid from the third upstream chamber 99 toward the third downstream chamber 100. The third valve portion 111 moves together with the third shaft portion 110. When the third opening and closing part 103 is at the close position indicated by the solid line in FIG. 4, the third valve portion 111 makes the third upstream chamber 99 and the third downstream chamber 100 fail to communicate with each other. When the third opening and closing part 103 is at the open position indicated by the two-dot chain line in FIG. 4, the third valve portion 111 makes the third upstream chamber 99 and the third downstream chamber 100 communicate with each other.

The third seal portion 112 can adhere to the third communication opening 107. The third seal portion 112 forms an outer circumference of the third valve portion 111. The third seal portion 112 may have an annular shape. The third seal portion 112 may be an O-ring having a torus shape.

The third biasing part 104 biases the fifth flexible film 101 in the first direction D1 of decreasing the volume of the third upstream chamber 99. The third biasing part 104 is disposed outside the third upstream chamber 99. The third biasing part 104 presses the third opening and closing part 103 via the fifth flexible film 101. The third biasing part 104 is, for example, a compression spring.

### Operation of Pressure Release Valve

The pressure release valve 31 reduces the pressure of the fluid flowing into the third upstream chamber 99 to make the fluid flow out from the third downstream chamber 100. The pressure of the fluid flowing into the third upstream chamber 99 is positive pressure. The pressure of the fluid flowing out from the third downstream chamber 100 is lower than the pressure of the fluid flowing into the third upstream chamber 99. The pressure in the third downstream chamber 100 may be negative pressure, the atmospheric pressure, or positive pressure.

The third opening and closing part 103 moves in accordance with a change in the pressure in the third upstream chamber 99. When the positive pressure in the third upstream chamber 99 increases, the fifth flexible film 101 is displaced in a direction of increasing the volume of the third upstream chamber 99 in the teeth of the biasing force of the third biasing part 104. The third opening and closing part 103 is pulled by the fifth flexible film 101 to move. The sixth flexible film 102 is displaced in sync with the third opening and closing part 103. The sixth flexible film 102 is displaced in a direction of decreasing the volume of the third upstream chamber 99 and increasing the volume of the third downstream chamber 100. The sixth flexible film 102 reduces the volume change of the third upstream chamber 99 due to the displacement of the fifth flexible film 101.

The third opening and closing part 103 is pulled by the fifth flexible film 101 to move to the open position. Therefore, the third upstream chamber 99 communicates with the third downstream chamber 100. The fluid flows out from the third upstream chamber 99 to the third downstream chamber 100.

When the positive pressure in the third upstream chamber 99 decreases, the fifth flexible film 101 is pushed by the third biasing part 104 and is displaced in a direction of decreasing the volume of the third upstream chamber 99. The third opening and closing part 103 and the sixth flexible film 102 move to the close position together with the fifth flexible film 101. Therefore, the outflow of the fluid from the third upstream chamber 99 to the third downstream chamber 100 is stopped.

In the third downstream chamber 100, the pressure receiving area of the third valve portion 111 may be the same as the pressure receiving area of the sixth flexible film 102. The area of the third valve portion 111 in contact with the fluid in the third downstream chamber 100 may be substantially the same as the area of the sixth flexible film 102 in contact with the fluid in the third downstream chamber 100. In this case, even when the pressure in the third downstream chamber 100 changes, the third opening and closing part 103 does not move from the close position.

### Negative Pressure Release Valve

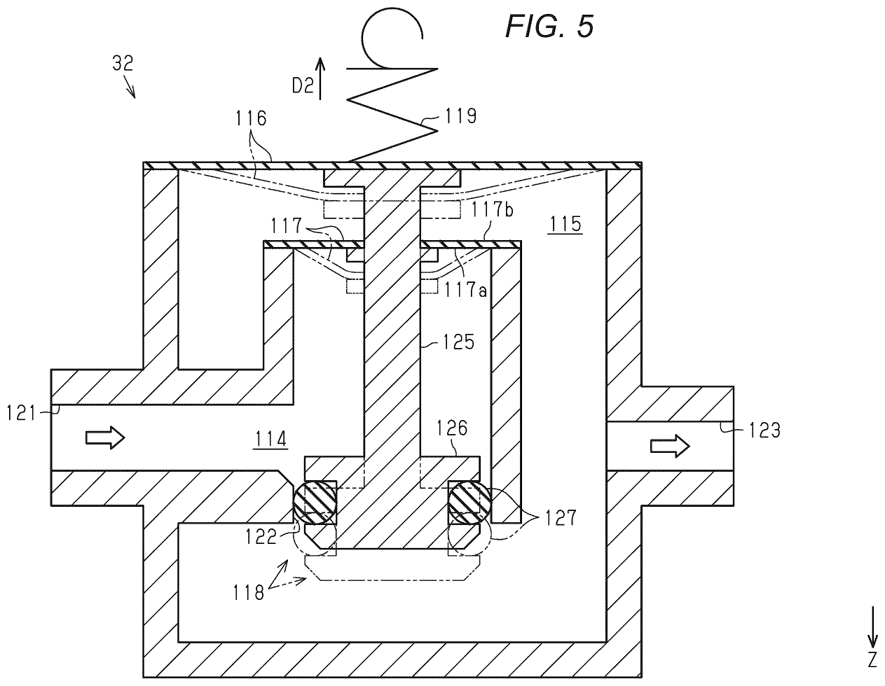

As shown in FIG. 5, the negative pressure release valve 32 includes a fourth upstream chamber 114 as an example of a first upstream chamber, and a fourth downstream chamber 115 as an example of a first downstream chamber. The fourth downstream chamber 115 includes a seventh flexible film 116 as an example of a first flexible film. The negative pressure release valve 32 includes an eighth flexible film 117 as an example of a second flexible film, a fourth opening and closing part 118 as an example of a first opening and closing part, and a fourth biasing part 119 as an example of a first biasing part. The fourth opening and closing part 118 is can move to a close position indicated by a solid line in FIG. 5 and an open position indicated by a two-dot chain line in FIG. 5. In the present embodiment, a state in which the fourth opening and closing part 118 is located at the close position is also referred to as a close state, and a state in which the fourth opening and closing part 118 is located at the open position is also referred to as an open state. In FIG. 5, the direction in which a fluid flows is indicated by an outlined arrow.

The fourth upstream chamber 114 has a fourth inflow port 121 as an example of a first inflow port. The fourth inflow port 121 in the present embodiment communicates with the atmosphere via the second gas flow path 18. The fluid flows into the fourth upstream chamber 114 via the fourth inflow port 121. The fluid handled by the negative pressure release valve 32 of the present embodiment is a gas.

The fourth downstream chamber 115 is disposed downstream of the fourth upstream chamber 114. The fourth downstream chamber 115 communicates with the fourth upstream chamber 114 downstream of the fourth upstream chamber 114 via a fourth communication opening 122 as an example of a first communication opening. The fourth downstream chamber 115 has a fourth outflow port 123 through which the fluid flows out. The fourth outflow port 123 in the present embodiment communicates with the second liquid storage unit 17 via the second gas flow path 18.

The seventh flexible film 116 forms a part of a wall of the fourth downstream chamber 115. The seventh flexible film 116 is formed of a flexible member having flexibility such as a diaphragm. The seventh flexible film 116 is displaced in accordance with a difference in pressure applied to an outer surface and an inner surface. The difference between the atmospheric pressure and the force applied by the fourth biasing part 119 is applied to the outer surface of the seventh flexible film 116. The pressure of the fluid in the fourth downstream chamber 115 is applied to the inner surface of the seventh flexible film 116. The seventh flexible film 116 in the close state indicated by the solid line in FIG. 5 is small in deflection. In the close state, the seventh flexible film 116 is preferably in a flat state with no deflection. In the close state, the seventh flexible film 116 may be in a state having a slight deflection. The deflection amount of the seventh flexible film 116 when the fourth opening and closing part 118 is in the close state indicated by the solid line in FIG. 5 may be smaller than the deflection amount of the seventh flexible film 116 when the fourth opening and closing part 118 is in the open state indicated by the two-dot chain line in FIG. 5.

The eighth flexible film 117 separates the fourth upstream chamber 114 from the fourth downstream chamber 115. The eighth flexible film 117 may be located on the fourth communication opening 122. The eighth flexible film 117 is located between the fourth communication opening 122 and the seventh flexible film 116. The fourth communication opening 122, the eighth flexible film 117, the seventh flexible film 116, and the fourth biasing part 119 may be arranged in this order in the second direction D2. The second direction D2 may be a direction opposite to the vertical direction Z.

The eighth flexible film 117 is displaced in accordance with a difference in the pressure applied to a seventh surface 117a and an eighth surface 117b. The pressure of the fluid in the fourth upstream chamber 114 is applied to the seventh surface 117a. The pressure of the fluid in the fourth downstream chamber 115 is applied to the eighth surface 117b. In the close state, the eighth flexible film 117 is preferably in a flat state with no deflection. In the close state, the eighth flexible film 117 may be in a state having a slight deflection. The deflection amount of the eighth flexible film 117 when the fourth opening and closing part 118 is in the close state indicated by the solid line in FIG. 5 may be smaller than the deflection amount of the eighth flexible film 117 when the fourth opening and closing part 118 is in the open state indicated by the two-dot chain line in FIG. 5.

The fourth opening and closing part 118 may include a fourth shaft portion 125 and a fourth valve portion 126. The fourth valve portion 126 may include a fourth seal portion 127. The fourth opening and closing part 118 can open and close the fourth communication opening 122.

The fourth shaft portion 125 is disposed over the fourth upstream chamber 114 and the fourth downstream chamber 115. The fourth shaft portion 125 is inserted into the eighth flexible film 117. A longitudinal direction of the fourth shaft portion 125 may be parallel to the second direction D2. The fourth shaft portion 125 may have a rod shape. The fourth shaft portion 125 may have a columnar shape. A diameter of the fourth shaft portion 125 is smaller than an inner diameter of the fourth communication opening 122.

The fourth shaft portion 125 can move so as to follow the displacement of the seventh flexible film 116 and the eighth flexible film 117. The fourth shaft portion 125 is fixed to the seventh flexible film 116 and the eighth flexible film 117 directly or via a fixation member. One end of the fourth shaft portion 125 is coupled to the seventh flexible film 116. The other end of the fourth shaft portion 125 is coupled to the fourth valve portion 126. The fourth shaft portion 125 moves so as to follow the displacement of the seventh flexible film 116 to thereby displace the eighth flexible film 117 and the fourth valve portion 126.

The fourth valve portion 126 is coupled to the fourth shaft portion 125. The fourth valve portion 126 can open and close the fourth communication opening 122. The fourth valve portion 126 can restrict the flow of the fluid from the fourth upstream chamber 114 toward the fourth downstream chamber 115. The fourth valve portion 126 moves together with the fourth shaft portion 125. When the fourth opening and closing part 118 is at the close position indicated by the solid line in FIG. 5, the fourth valve portion 126 makes the fourth upstream chamber 114 and the fourth downstream chamber 115 fail to communicate with each other. When the fourth opening and closing part 118 is at the open position indicated by the two-dot chain line in FIG. 5, the fourth valve portion 126 makes the fourth upstream chamber 114 and the fourth downstream chamber 115 communicate with each other.

The fourth seal portion 127 can adhere to the fourth communication opening 122. The fourth seal portion 127 forms an outer circumference of the fourth valve portion 126. The fourth seal portion 127 may have an annular shape. The fourth seal portion 127 may be an O-ring having a torus shape.

The fourth biasing part 119 biases the seventh flexible film 116 in the second direction D2 of increasing the volume of the fourth downstream chamber 115. The fourth biasing part 119 is disposed outside the fourth downstream chamber 115. The fourth biasing part 119 pulls the fourth opening and closing part 118 via the seventh flexible film 116. The fourth biasing part 119 is, for example, a tension spring.

### Operation of Negative Pressure Release Valve

The negative pressure release valve 32 reduces the pressure of the fluid flowing into the fourth upstream chamber 114 to make the fluid flow out from the fourth downstream chamber 115. The pressure of the fluid flowing out from the fourth downstream chamber 115 is negative pressure. The pressure of the fluid flowing into the fourth upstream chamber 114 is higher than the pressure of the fluid flowing out from the fourth downstream chamber 115. The fluid flowing into the fourth upstream chamber 114 may be negative pressure or positive pressure.

The fourth opening and closing part 118 moves in accordance with a change in the pressure in the fourth downstream chamber 115. When the negative pressure in the fourth downstream chamber 115 increases, the seventh flexible film 116 is displaced in a direction of decreasing the volume of the fourth downstream chamber 115 in the teeth of the biasing force of the fourth biasing part 119. The fourth opening and closing part 118 is pushed by the seventh flexible film 116 to move. The eighth flexible film 117 is displaced in sync with the fourth opening and closing part 118. The eighth flexible film 117 is displaced in a direction of decreasing the volume of the fourth upstream chamber 114 and increasing the volume of the fourth downstream chamber 115. The eighth flexible film 117 reduces the volume change of the fourth downstream chamber 115 due to the displacement of the seventh flexible film 116.

The fourth opening and closing part 118 is pushed by the seventh flexible film 116 to move to the open position. Therefore, the fourth upstream chamber 114 communicates with the fourth downstream chamber 115. The fluid is supplied from the fourth upstream chamber 114 to the fourth downstream chamber 115.

When the negative pressure in the fourth downstream chamber 115 decreases, the seventh flexible film 116 is pulled by the fourth biasing part 119 and is displaced in a direction of increasing the volume of the fourth downstream chamber 115. The fourth opening and closing part 118 and the seventh flexible film 116 move to the close position together with the seventh flexible film 116. Therefore, the supply of the fluid from the fourth upstream chamber 114 to the fourth downstream chamber 115 is stopped.

In the fourth upstream chamber 114, the pressure receiving area of the fourth valve portion 126 may be the same as the pressure receiving area of the eighth flexible film 117. The area of the fourth valve portion 126 in contact with the fluid in the fourth upstream chamber 114 may be substantially the same as the area of the eighth flexible film 117 in contact with the fluid in the fourth upstream chamber 114. In this case, even when the pressure in the fourth upstream chamber 114 increases, the fourth opening and closing part 118 does not move from the close position.

### Function of Embodiment

The function of the present embodiment will be described.

As shown in FIG. 1, the liquid ejection apparatus 11 changes the pressure of the liquid supplied to the liquid ejection unit 12 by opening and closing the first upstream valve 22, the second upstream valve 23, the first downstream valve 24, and the second downstream valve 25.

For example, when printing is performed on the medium 34, the liquid ejection apparatus 11 may make the liquid flow through the main flow path 52. Specifically, the liquid ejection apparatus 11 opens the first upstream valve 22 and the first downstream valve 24, and closes the second upstream valve 23 and the second downstream valve 25. The liquid flowing through the main flow path 52 passes through the pressure control valve 29, the liquid ejection unit 12, and the negative pressure control valve 30. The liquid ejection apparatus 11 supplies the liquid low in pressure to the liquid ejection unit 12, and makes low negative pressure act on the liquid ejection unit 12.

For example, when the liquid ejection unit 12 is filled with the liquid, the liquid ejection apparatus 11 may make the liquid flow through the bypass flow path 53. Specifically, the liquid ejection apparatus 11 closes the first upstream valve 22 and the first downstream valve 24, and opens the second upstream valve 23 and the second downstream valve 25. The liquid passes through the first bypass flow path 58, the liquid ejection unit 12, and the second bypass flow path 59 without passing through the pressure control valve 29 and the negative pressure control valve 30. The liquid ejection apparatus 11 supplies the liquid ejection unit 12 with the liquid high in pressure, and makes the high negative pressure act on the liquid ejection unit 12.

### Advantages of Embodiment

Advantages of the present embodiment will be described.
(1-1) The circulation flow path 21 includes the main flow path 52 and the bypass flow path 53. The pressure control valve 29 and the negative pressure control valve 30 are disposed in the main flow path 52, but are not disposed in the bypass flow path 53. Therefore, by selectively using the bypass flow path 53 and the main flow path 52, the pressure and the flow rate of the liquid supplied to the liquid ejection unit 12 can be changed.
(1-2) The first bypass flow path 58 couples upstream and downstream of the pressure control valve 29. By using the first bypass flow path 58, the liquid can flow without passing through the pressure control valve 29. The second bypass flow path 59 couples upstream and downstream of the negative pressure control valve 30. By using the second bypass flow path 59, the liquid can flow without passing through the negative pressure control valve 30. Therefore, since the liquid can be circulated at a high flow rate by using the first bypass flow path 58 and the second bypass flow path 59, it is possible to make it easy to discharge the air bubbles.
(1-3) For example, when the liquid is supplied by a diaphragm pump, pulsation occurs. In this regard, the pressure pump 61 pressurizes the inside of the first liquid storage unit 15. The pressure reducing pump 62 reduces the pressure in the second liquid storage unit 17. By applying pressure respectively to the liquid stored in the first liquid storage unit 15 and the liquid stored in the second liquid storage unit 17, it is possible to stably circulate the liquid.
(1-4) In the pressure control valve 29, the first opening and closing part 68 opens in accordance with the pressure of the first downstream chamber 65. Therefore, even when the pressure of the first upstream chamber 64 fluctuates, the pressure of the first downstream chamber 65 is adjusted to the preset pressure. Therefore, it is possible to shorten the time required for switching from the state in which the liquid flows through the main flow path 52 to the state in which the liquid flows through the bypass flow path 53.
(1-5) In the negative pressure control valve 30, the second opening and closing part 83 opens in accordance with the pressure of the second upstream chamber 79. Therefore, even when the pressure of the second downstream chamber 80 fluctuates, the pressure of the second upstream chamber 79 is adjusted to the preset pressure. Therefore, it is possible to shorten the time required for switching from the state in which the liquid flows through the main flow path 52 to the state in which the liquid flows through the bypass flow path 53.
(1-6) The direction in which the first biasing part 69 biases the first flexible film 66 is a direction of decreasing the volume of the first downstream chamber 65. Therefore, the pressure of the liquid which flows out can be adjusted to appropriate positive pressure.
(1-7) The moisturizing unit 13 keeps the humidity of the liquid which is circulating. Therefore, an increase in the viscosity of the liquid can be suppressed.

### MODIFIED EXAMPLES

The present embodiment can be implemented with modifications described below. The present embodiment and the following modified examples can be implemented in combination with each other as long as no technical inconsistencies are involved.

### First Modified Example

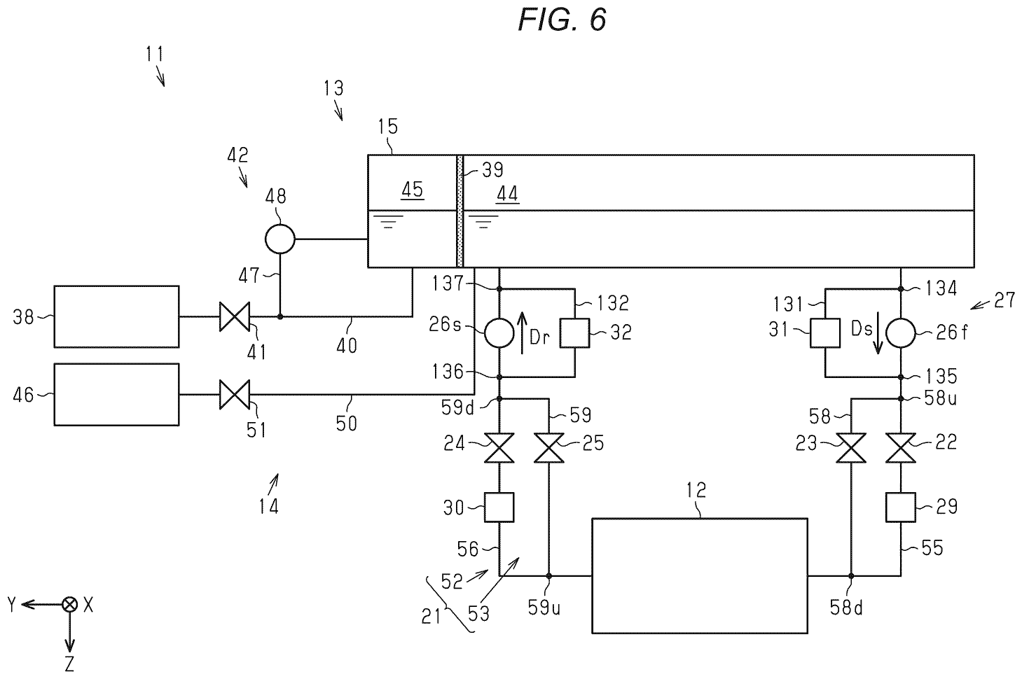

As shown in FIG. 6, the first liquid storage unit 15 as an example of a liquid storage unit may include the moisture permeable film 39. The moisture permeable film 39 may partition the inside of the first liquid storage unit 15 into the liquid chamber 44 and the moisturizing liquid chamber 45. The first liquid storage unit 15 is coupled to the main flow path 52. The upstream end in the supply direction Ds of the supply flow path 55 may be coupled to the liquid chamber 44. The downstream end in the recovery direction Dr of the recovery flow path 56 may be coupled to the liquid chamber 44.

The pressure change mechanism 27 may include a first liquid pump 26f and a second liquid pump 26s. The liquid ejection apparatus 11 may include a first relief flow path 131 and a second relief flow path 132.

The first liquid pump 26f is disposed upstream of the pressure control valve 29 in the main flow path 52. The first liquid pump 26f may be disposed in the supply flow path 55 between the first liquid storage unit 15 and the first upstream valve 22. The first liquid pump 26f makes the liquid in the supply flow path 55 flow in the supply direction Ds.

The first relief flow path 131 couples upstream of the first liquid pump 26f and downstream of the first liquid pump 26f to each other in the supply direction Ds. The first relief flow path 131 couples a first upstream coupling part 134 and a second upstream coupling part 135 in the supply flow path 55. The first upstream coupling part 134 is disposed between the first liquid storage unit 15 and the first liquid pump 26f in the supply direction Ds. The second upstream coupling part 135 is disposed between the first liquid pump 26f and the first upstream valve 22 in the supply direction Ds.

The pressure release valve 31 may be disposed in the first relief flow path 131. In the pressure release valve 31, the third inflow port 106 communicates with the second upstream coupling part 135 via the first relief flow path 131. In the pressure release valve 31, the third outflow port 108 communicates with the first upstream coupling part 134 via the first relief flow path 131. The pressure release valve 31 becomes in the open state when the pressure between the first liquid pump 26f and the first upstream valve 22 becomes higher than predetermined pressure. The pressure release valve 31 circulates the liquid in the supply flow path 55 between the first upstream coupling part 134 and the second upstream coupling part 135 and in the first relief flow path 131.

The second liquid pump 26s is disposed downstream of the negative pressure control valve 30 in the main flow path 52. The second liquid pump 26s may be disposed in the recovery flow path 56 between the first liquid storage unit 15 and the first downstream valve 24. The second liquid pump 26s makes the liquid in the recovery flow path 56 flow in the recovery direction Dr.

The second relief flow path 132 couples upstream of the second liquid pump 26s and downstream of the second liquid pump 26s in the recovery direction Dr. The second relief flow path 132 couples a first downstream coupling part 136 and a second downstream coupling part 137 in the recovery flow path 56. The first downstream coupling part 136 is disposed between the first downstream valve 24 and the negative pressure control valve 30 in the recovery direction Dr. The second downstream coupling part 137 is disposed between the second liquid pump 26s and the first liquid storage unit 15 in the recovery direction Dr.

The negative pressure release valve 32 may be disposed in the second relief flow path 132. In the negative pressure release valve 32, the fourth inflow port 121 communicates with the second downstream coupling part 137 via the second relief flow path 132. In the negative pressure release valve 32, the fourth outflow port 123 communicates with the first downstream coupling part 136 via the second relief flow path 132. The negative pressure release valve 32 becomes in the open state when the pressure between the second liquid pump 26s and the first downstream valve 24 becomes lower than predetermined pressure. The negative pressure release valve 32 circulates the liquid in the recovery flow path 56 between the first downstream coupling part 136 and the second downstream coupling part 137 and in the second relief flow path 132.

The first liquid storage unit 15 is coupled to the main flow path 52. Since the circulation flow path 21 can be formed with respect to one first liquid storage unit 15, the liquid ejection apparatus 11 can be reduced in size compared to when forming the circulation flow path 21 with respect to a plurality of liquid storage units.

### Second Modified Example

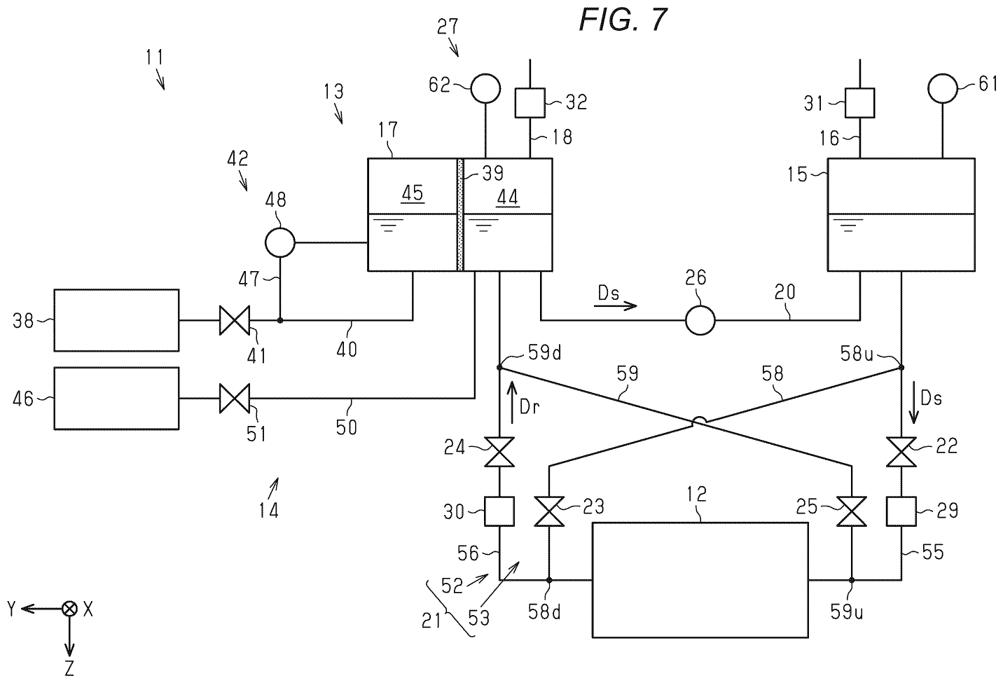

As illustrated in FIG. 7, the liquid ejection unit 12 may be located between the first downstream end 58d and the second upstream end 59u.

In the first bypass flow path 58, the first upstream end 58u may be located in the supply flow path 55, and the first downstream end 58d may be located in the recovery flow path 56. The first bypass flow path 58 may branch from the supply flow path 55 and merge with the recovery flow path 56.

The first upstream end 58u may be located upstream of the pressure control valve 29. The first upstream end 58u may be located upstream of the first upstream valve 22. The first downstream end 58d may be located upstream of the negative pressure control valve 30. The first downstream end 58d may be located between the liquid ejection unit 12 and the negative pressure control valve 30.

In the second bypass flow path 59, the second upstream end 59u may be located in the supply flow path 55, and the second downstream end 59d may be located in the recovery flow path 56. The second bypass flow path 59 may branch from the supply flow path 55 and merge with the recovery flow path 56.

The second upstream end 59u may be located downstream of the pressure control valve 29. The second upstream end 59u may be located between the pressure control valve 29 and the liquid ejection unit 12. The second downstream end 59d may be located downstream of the negative pressure control valve 30. The second downstream end 59d may be located between the negative pressure control valve 30 and the second liquid storage unit 17.

When the liquid is fed to the liquid ejection unit 12 with the main flow path 52, the liquid ejection apparatus 11 opens the first upstream valve 22 and the first downstream valve 24, and closes the second upstream valve 23 and the second downstream valve 25. In this case, the liquid flows through the order of the supply flow path 55, the liquid ejection unit 12, and the recovery flow path 56 in this order.

When the liquid is fed to the liquid ejection unit 12 with the bypass flow path 53, the liquid ejection unit 12 closes the first upstream valve 22 and the first downstream valve 24, and opens the second upstream valve 23 and the second downstream valve 25. In this case, the liquid flowing through the first bypass flow path 58 is fed from the first downstream end 58d to the recovery flow path 56, and flows into the liquid ejection unit 12 from the recovery flow path 56. The liquid in the liquid ejection unit 12 flows out to the supply flow path 55, and is fed from the second upstream end 59u to the second liquid storage unit 17 via the second bypass flow path 59.

The liquid ejection unit 12 is located between the first downstream end 58d located in the recovery flow path 56, and the second upstream end 59u located in the supply flow path 55. Therefore, the direction in which liquid flows through the main flow path 52 to the liquid ejection unit 12 and the direction in which the liquid flows through the bypass flow path 53 to the liquid ejection unit 12 are opposite to each other. By reversing the flow direction of the liquid, it is possible to discharge air bubbles and stir the liquid.

The first upstream end 58u is located upstream of the pressure control valve 29. The second downstream end 59d is located downstream of the negative pressure control valve 30. Therefore, by using the first bypass flow path 58 and the second bypass flow path 59, it is possible to make the liquid flow without passing through the pressure control valve 29 and the negative pressure control valve 30.

### Third Modified Example

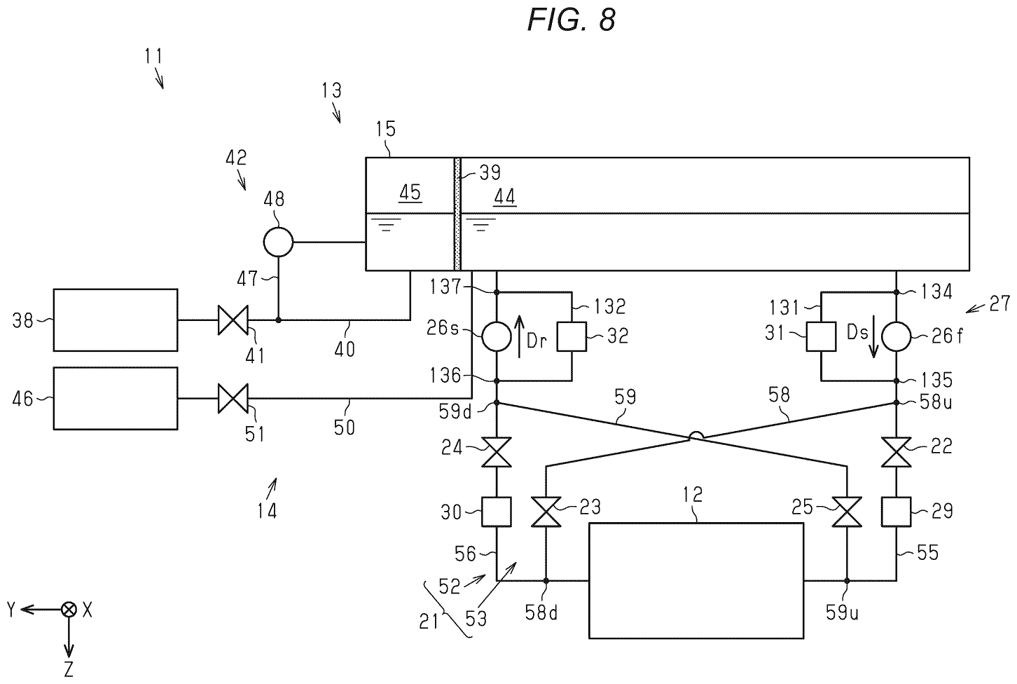

As shown in FIG. 8, the first upstream end 58u may be located between the second upstream coupling part 135 and the first upstream valve 22 in the supply flow path 55. The second downstream end 59d may be located between the first downstream valve 24 and the first downstream coupling part 136 in the recovery flow path 56.

### Fourth Modified Example

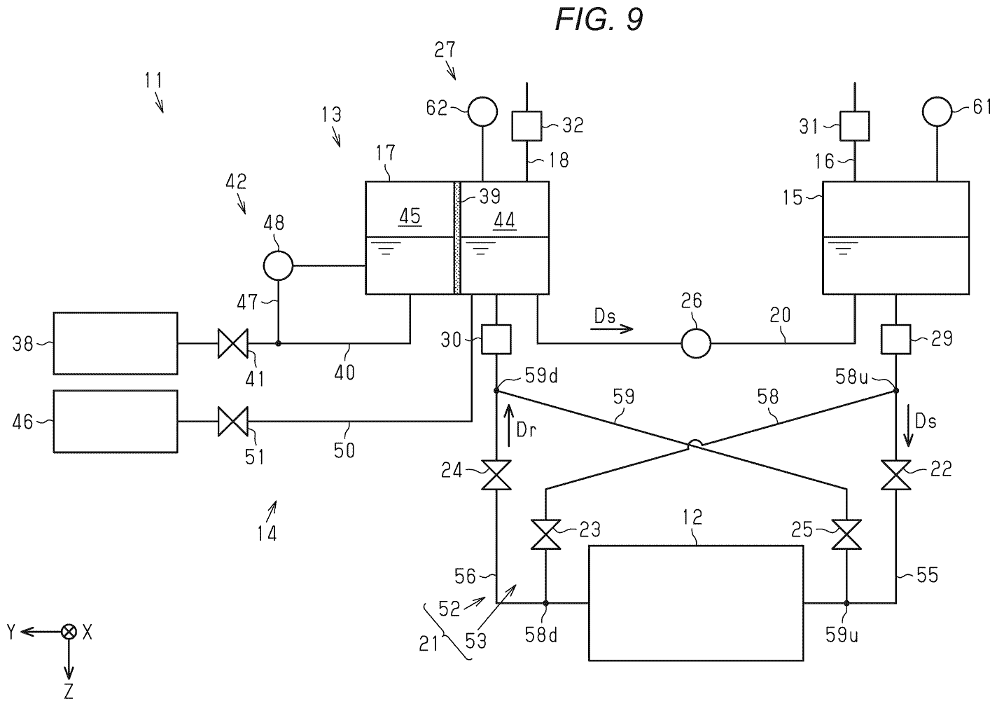

As shown in FIG. 9, the pressure control valve 29 may be located upstream of the first upstream valve 22. The pressure control valve 29 may be located between the first liquid storage unit 15 and the first upstream valve 22.

The first upstream end 58u may be located downstream of the pressure control valve 29. The first upstream end 58u may be located between the pressure control valve 29 and the first upstream valve 22. The first downstream end 58d may be located upstream of the negative pressure control valve 30. The first downstream end 58d may be located between the liquid ejection unit 12 and the first downstream valve 24.

The negative pressure control valve 30 may be located downstream of the first downstream valve 24. The negative pressure control valve 30 may be located between the first downstream valve 24 and the second liquid storage unit 17.

The second upstream end 59u may be located downstream of the pressure control valve 29. The second upstream end 59u may be located between the first upstream valve 22 and the liquid ejection unit 12. The second downstream end 59d may be located upstream of the negative pressure control valve 30. The second downstream end 59d may be located between the first downstream valve 24 and the negative pressure control valve 30.

The first downstream end 58d is located upstream of the negative pressure control valve 30. The second upstream end 59u is located downstream of the pressure control valve 29. Therefore, the liquid passing through the first bypass flow path 58 can be made to flow to the second bypass flow path 59 via the liquid ejection unit 12.

### Fifth Modified Example

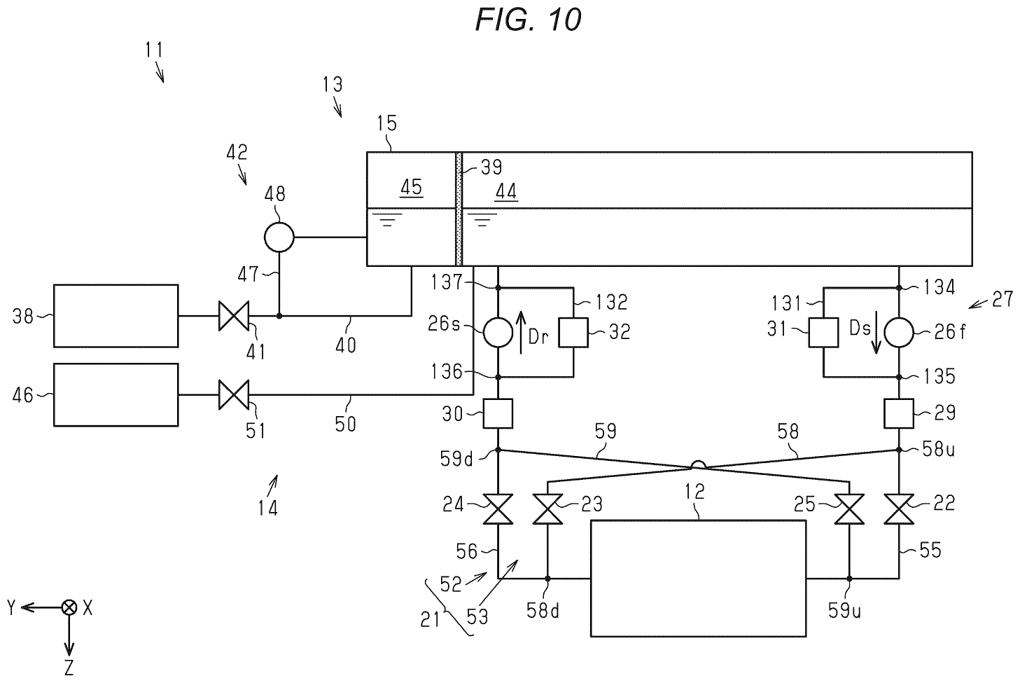

As shown in FIG. 10, the first upstream coupling part 134, the first liquid pump 26f, the second upstream coupling part 135, the pressure control valve 29, the first upstream end 58u, the first upstream valve 22, and the second upstream end 59u may be located in the supply flow path 55 in this order from upstream in the supply direction Ds. The first downstream end 58d, the first downstream valve 24, the second downstream end 59d, the negative pressure control valve 30, the first downstream coupling part 136, the second liquid pump 26s, and the second downstream coupling part 137 may be located in the recovery flow path 56 in this order from upstream in the recovery direction Dr.

### Sixth Modified Example

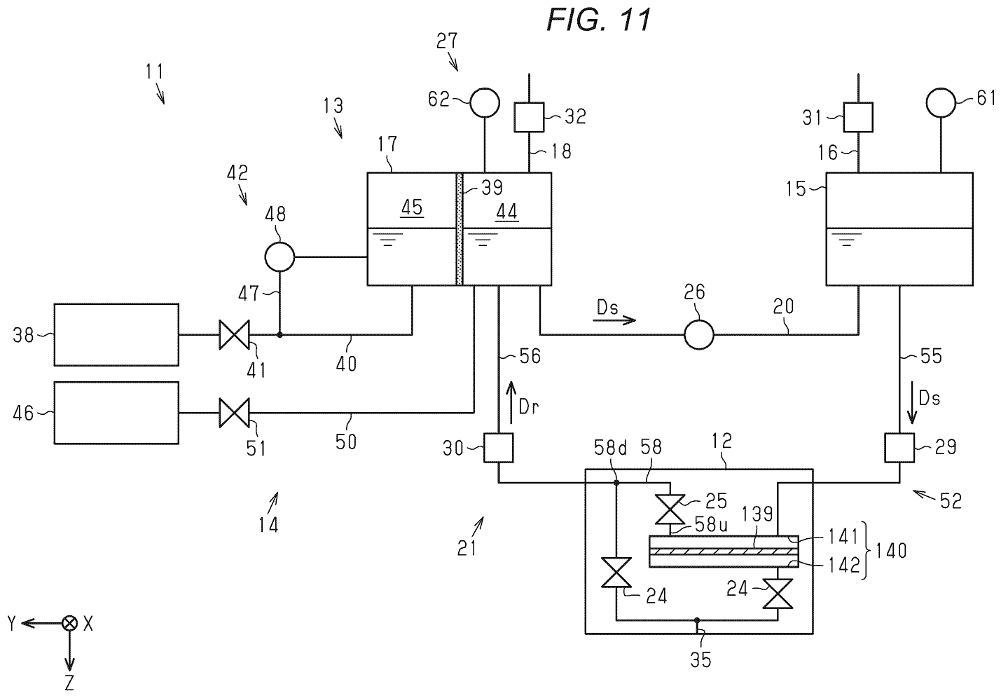

As illustrated in FIG. 11, the liquid ejection unit 12 may include a filter 139 and a filter chamber 140.

The filter 139 is provided to the filter chamber 140. The filter 139 filters the liquid. The filter 139 can capture bubbles, foreign matters, and so on contained in the liquid. The filter 139 partitions the filter chamber 140 into a filter anterior chamber 141 and a filter posterior chamber 142.

A downstream end of the supply flow path 55 may be coupled to the filter anterior chamber 141. An upstream end of the recovery flow path 56 may be coupled to the filter posterior chamber 142.

The liquid ejection apparatus 11 may include a plurality of first downstream valves 24. The plurality of first downstream valves 24 may be provided in the liquid ejection unit 12. The one or more nozzles 35 may communicate with the recovery flow path 56 between two of the first downstream valves 24.

In the first bypass flow path 58 as an example of the bypass flow path, the first upstream end 58u may be located in the filter anterior chamber 141. In the first bypass flow path 58, the first downstream end 58d of the may be located downstream of the filter posterior chamber 142. The first downstream end 58d may be coupled to the recovery flow path 56. The first downstream end 58d of the first bypass flow path 58 may be located upstream of the negative pressure control valve 30. The second downstream valve 25 may be disposed in the first bypass flow path 58.

When the plurality of first downstream valves 24 is opened and the second downstream valve 25 is closed, the liquid passes through the supply flow path 55, the filter anterior chamber 141, the filter 139, the filter posterior chamber 142, and the recovery flow path 56. That is, the liquid flows while passing through the pressure control valve 29, the filter 139, and the negative pressure control valve 30.

When the plurality of first downstream valves 24 is closed and the second downstream valve 25 is opened, the liquid flows from the filter anterior chamber 141 to the recovery flow path 56 via the first bypass flow path 58. That is, the liquid in the filter anterior chamber 141 flows out to the bypass flow path 53 without passing through the filter 139.

In the first bypass flow path 58, the first upstream end 58u is located in the filter anterior chamber 141. Therefore, it is possible to make it easy to discharge foreign matters such as bubbles captured by the filter 139 via the first bypass flow path 58.

In the first bypass flow path 58, the first downstream end 58d is located upstream of the negative pressure control valve 30. Therefore, even when the liquid flows through the first bypass flow path 58, the fluctuation of the pressure of the liquid supplied to the liquid ejection unit 12 can be reduced.

### Seventh Modified Example

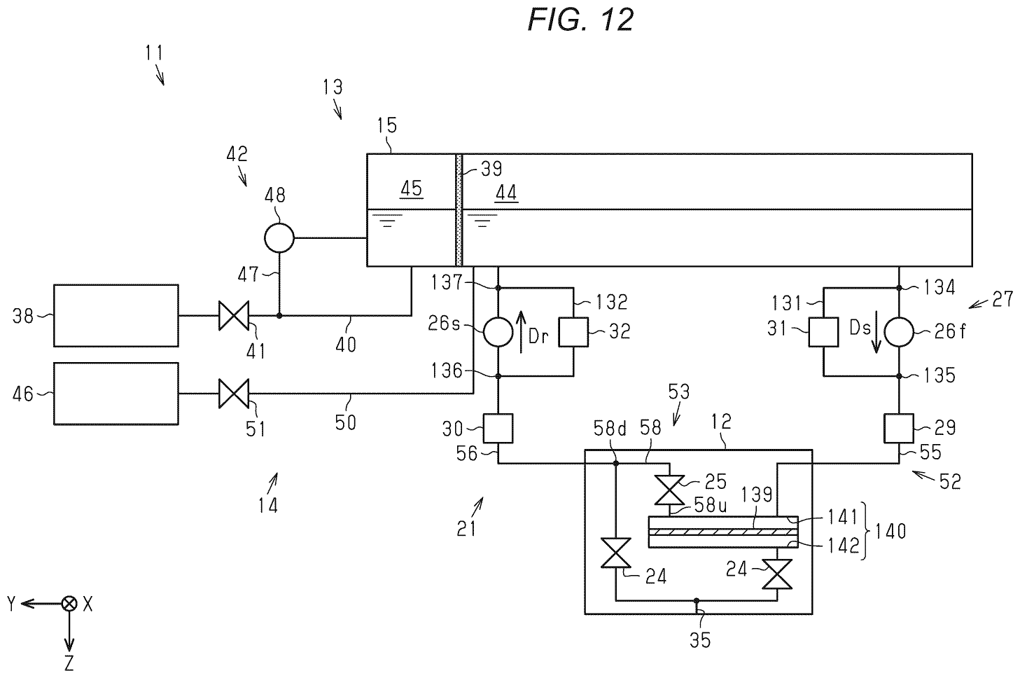

As illustrated in FIG. 12, the supply flow path 55 may couple the first liquid storage unit 15 and the filter anterior chamber 141 to each other. The recovery flow path 56 may couple the filter posterior chamber 142 and the first liquid storage unit 15 to each other.

### Eighth Modified Example

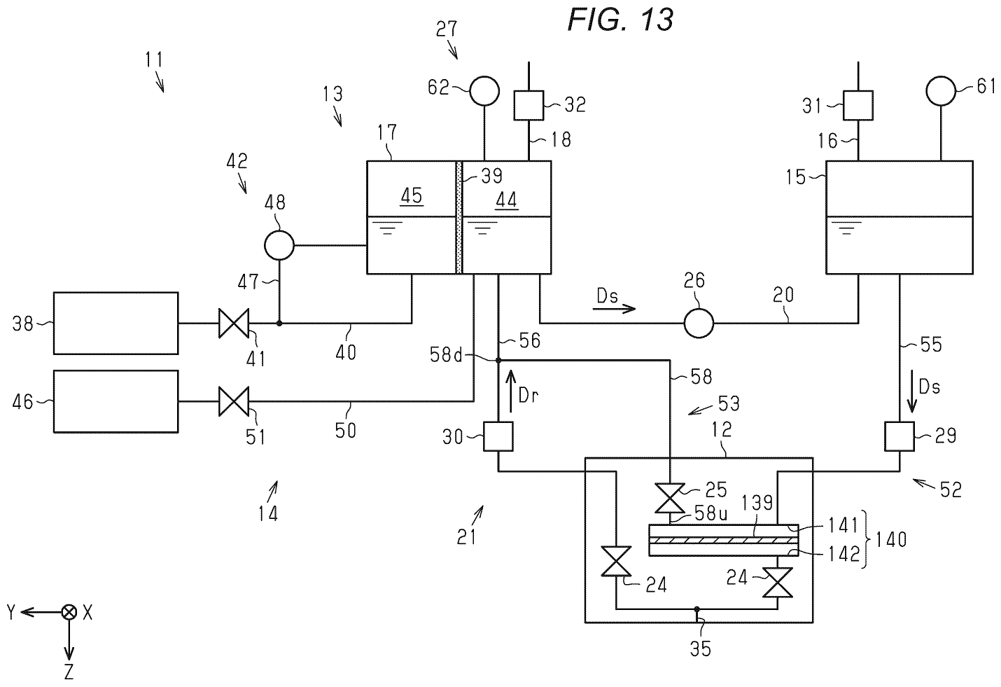

As shown in FIG. 13, the first downstream end 58d may be located downstream of the negative pressure control valve 30. The liquid which flows out from the filter anterior chamber 141 to the first bypass flow path 58 may be fed to the second liquid storage unit 17 without passing through the negative pressure control valve 30.

In the first bypass flow path 58, the first downstream end 58d is located downstream of the negative pressure control valve 30. Since it is possible to make the liquid flow at a high flow rate without passing through the negative pressure control valve 30, it is possible to make it easy to discharge air bubbles.

### Ninth Modified Example

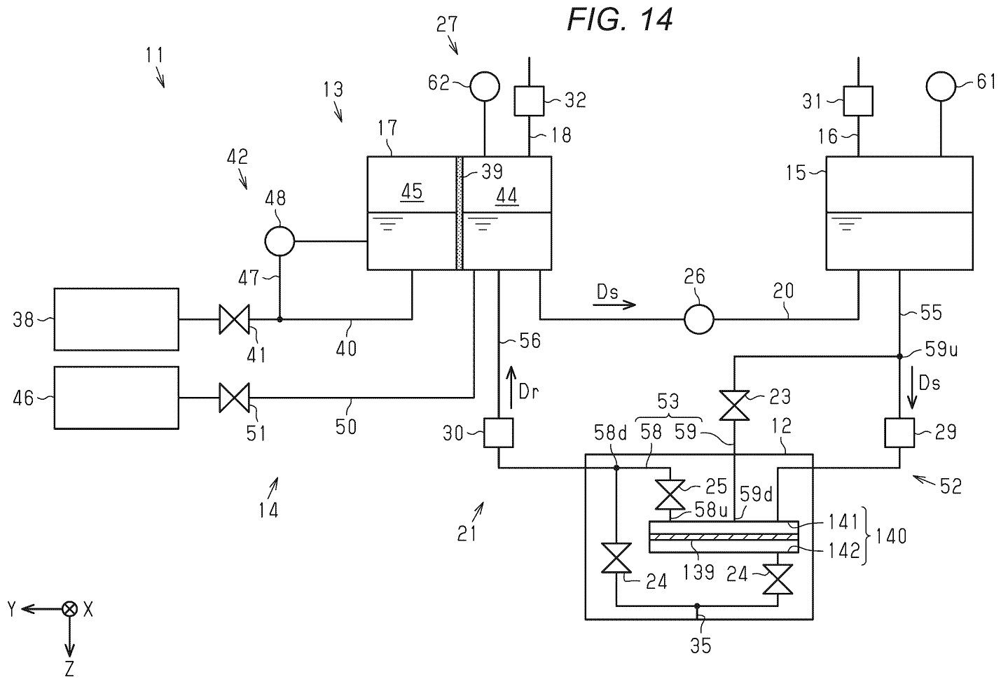

As illustrated in FIG. 14, the second bypass flow path 59 may couple the supply flow path 55 and the filter anterior chamber 141 to each other. The second bypass flow path 59 may be provided with the second upstream valve 23. The second upstream end 59u may be located upstream of the pressure control valve 29. The second downstream end 59d may be located in the filter anterior chamber 141. When the second upstream valve 23 is opened, the liquid can be fed to the filter anterior chamber 141 without passing through the pressure control valve 29.

The second bypass flow path 59 couples upstream of the pressure control valve 29 to the anterior chamber of the filter 139. By using the second bypass flow path 59, it is possible to supply the liquid to the filter anterior chamber 141 without passing through the pressure control valve 29.

### Tenth Modified Example

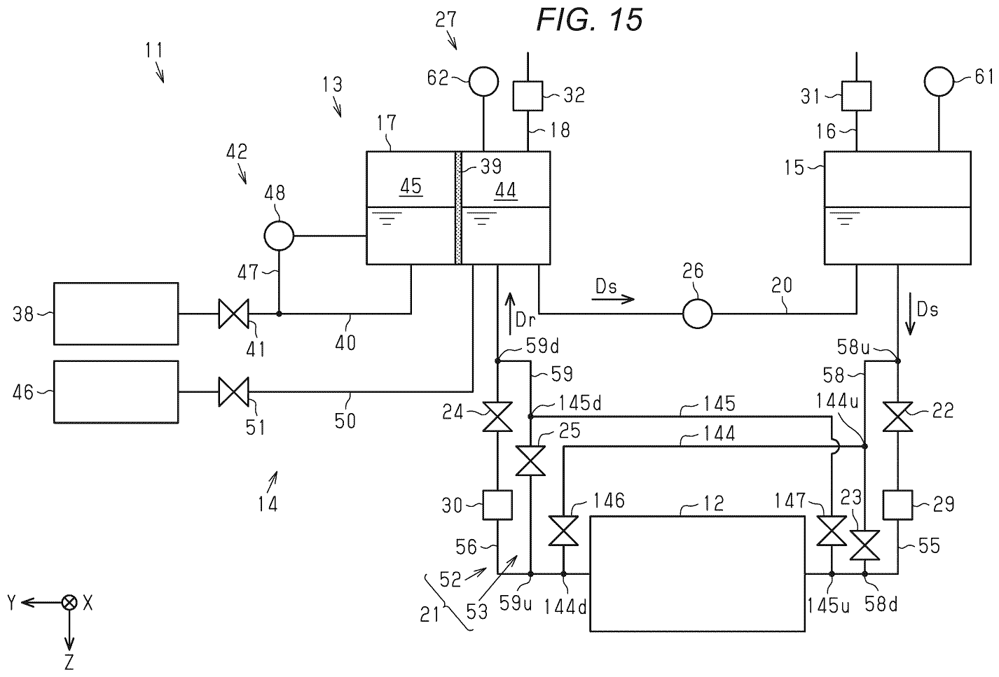

As illustrated in FIG. 15, the liquid ejection apparatus 11 may include a third bypass flow path 144, a fourth bypass flow path 145, a third upstream valve 146, and a third downstream valve 147.

The third bypass flow path 144 may branch from the first bypass flow path 58. The third bypass flow path 144 may couple the first bypass flow path 58 and the recovery flow path 56 to each other. In the third bypass flow path 144, a third upstream end 144u of may be located in the first bypass flow path 58. The third upstream end 144u may be located between the first upstream end 58u and the second upstream valve 23. In the third bypass flow path 144, the third downstream end 144d may be located in the recovery flow path 56. The third downstream end 144d may be located upstream of the negative pressure control valve 30.

The fourth bypass flow path 145 may merge with the second bypass flow path 59. The fourth bypass flow path 145 may couple the supply flow path 55 and the second bypass flow path 59 to each other. In the fourth bypass flow path 145, a fourth upstream end 145u may be located in the supply flow path 55. The fourth upstream end 145u may be located downstream of the pressure control valve 29. In the fourth bypass flow path 145, a fourth downstream end 145d may be located in the second bypass flow path 59. In the fourth bypass flow path 145, the fourth downstream end 145d may be located between the second downstream valve 25 and the second downstream end 59d.

The liquid ejection apparatus 11 can change the pressure, the flow rate, and the direction of the liquid supplied to the liquid ejection unit 12 by opening and closing the first upstream valve 22, the second upstream valve 23, the third upstream valve 146, the first downstream valve 24, the second downstream valve 25, and the third downstream valve 147.

For example, when printing is performed on the medium 34, the liquid ejection apparatus 11 may make the liquid flow through the supply flow path 55 and the recovery flow path 56. Specifically, the liquid ejection apparatus 11 opens the first upstream valve 22 and the first downstream valve 24, and closes the second upstream valve 23, the third upstream valve 146, the second downstream valve 25, and the third downstream valve 147. The liquid passes through the pressure control valve 29, the liquid ejection unit 12, and the negative pressure control valve 30. The liquid ejection apparatus 11 supplies the liquid low in pressure to the liquid ejection unit 12, and makes low negative pressure act on the liquid ejection unit 12.

For example, when filling the liquid ejection unit 12 with the liquid, the liquid ejection apparatus 11 may make the liquid flow through the first bypass flow path 58 and the second bypass flow path 59. Specifically, the liquid ejection apparatus 11 closes the first upstream valve 22, the third upstream valve 146, the first downstream valve 24, and the third downstream valve 147, and opens the second upstream valve 23 and the second downstream valve 25. The liquid passes through the first bypass flow path 58, the liquid ejection unit 12, and the second bypass flow path 59 without passing through the pressure control valve 29 and the negative pressure control valve 30. The liquid ejection apparatus 11 supplies the liquid ejection unit 12 with the liquid high in pressure, and makes the high negative pressure act on the liquid ejection unit 12.

By using the first bypass flow path 58 and the second bypass flow path 59, the liquid can be circulated at a high flow rate. When the liquid is circulated at a high flow rate, it is possible to make it easy to discharge the air bubbles.

For example, when supplying the liquid to the liquid ejection unit 12 in a direction opposite to the direction of the liquid during printing, the liquid ejection unit 12 closes the first upstream valve 22, the second upstream valve 23, the first downstream valve 24, and the second downstream valve 25, and opens the third upstream valve 146 and the third downstream valve 147. In this case, the liquid which flows through the third bypass flow path 144 is fed from the third downstream end 144d to the recovery flow path 56, and flows into the liquid ejection unit 12 from the recovery flow path 56. The liquid in the liquid ejection unit 12 flows out to the supply flow path 55, and is fed from the fourth upstream end 145u to the second liquid storage unit 17 via the fourth bypass flow path 145. By reversing the direction in which the liquid flows through the liquid ejection unit 12, it is possible to discharge the air bubbles or to stir the liquid.

### Other Modified Examples

The first seal portion 77 may be provided to the first communication opening 72. The second seal portion 92 may be provided to the second communication opening 87. The third seal portion 112 may be provided to the third communication opening 107. The fourth seal portion 127 may be provided to the fourth communication opening 122.

The first shaft portion 75 and the second flexible film 67 may be integrally formed. The second shaft portion 90 and the fourth flexible film 82 may be integrally formed. The third shaft portion 110 and the sixth flexible film 102 may be integrally formed. The fourth shaft portion 125 and the eighth flexible film 117 may be integrally formed.

The liquid ejection apparatus 11 may include the negative pressure release valve 32 instead of the pressure control valve 29. In this case, the negative pressure control valve 30 functions as the first pressure control valve. The negative pressure release valve 32 controls the negative pressure at the liquid ejection unit 12 side in the supply flow path 55. The negative pressure release valve 32 becomes in the open state when the negative pressure at the liquid ejection unit 12 side is increased to thereby supply the liquid to the liquid ejection unit 12. The direction in which the fourth biasing part 119 biases the seventh flexible film 116 is a direction of increasing the volume of the fourth downstream chamber 115. Therefore, it is possible to adjust the pressure of the liquid which flows out to appropriate negative pressure.

The pressure pump 61 may be provided separately from the liquid ejection apparatus 11.

The pressure control valve 29 may be disposed in a pressurized flow path which couples the pressure pump 61 and the first liquid storage unit 15 to each other. The pressure control valve 29 may become in the open state to supply the pressurized air to the first liquid storage unit 15 when the positive pressure in the first liquid storage unit 15 is reduced. The pressure control valve 29 may adjust the pressure of the gas.

The negative pressure control valve 30 may be provided in a reduced-pressure flow path which couples the pressure reducing pump 62 and the second liquid storage unit 17 to each other. The negative pressure control valve 30 may become in the open state to reduce the pressure in the second liquid storage unit 17 when the negative pressure in the second liquid storage unit 17 decreases. The negative pressure control valve 30 may adjust the pressure of the gas.

The liquid ejection apparatus 11 may include a plurality of liquid flow devices each including the first liquid storage unit 15, the second liquid storage unit 17, the main flow path 52, and the bypass flow path 53. The plurality of liquid flow devices may supply respective types of liquid different from each other to the liquid ejection unit 12. The liquids different in type are, for example, different colors of ink. The one pressure pump 61 may pressurize a plurality of first liquid storage units 15. The one pressure reducing pump 62 may reduce the pressure of a plurality of second liquid storage units 17.

The liquid ejection apparatus 11 may be a liquid ejection apparatus that jets or ejects a liquid other than ink. The state of the liquid to be ejected from the liquid ejection apparatus as a minute amount of droplet includes a particle state, a teardrop state, and a state of tailing like a thread. The liquid mentioned here is only required to be a material which can be ejected from the liquid ejection apparatus. For example, the liquid is only required to be a substance in a state in which the substance is in the liquid phase, and includes a liquid material high or low in viscosity, sol, gel water, other inorganic solvents, organic solvents, solutions, and a fluid material such as liquid resin, liquid metal, and metal melt. The liquid includes not only the liquid as a state of a substance, but also a liquid in which particles of a functional material made of a solid such as a pigment or a metal particle are dissolved, dispersed, or mixed in a solvent. As typical examples of the liquid, there can be cited the ink explained in the embodiment described above, liquid crystal, and so on. Here, the ink includes various types of liquid compositions such as general water-based ink, oil-based ink, gel ink, and hot melt ink. As a specific example of the liquid ejection apparatus, there is an apparatus that ejects a liquid containing a material such as an electrode material or a coloring material used in, for example, manufacture of a liquid crystal display, an electroluminescence display, a surface-emitting display, and a color filter in a dispersed or dissolved form. The liquid ejection apparatus may be an apparatus that ejects a bioorganic substance used for manufacturing a biochip, an apparatus that is used as a precision pipette and ejects a liquid to be a sample, a textile printing apparatus, a micro dispenser, or the like. The liquid ejection apparatus may be an apparatus that ejects lubricating oil to a precision machine such as a timepiece or a camera in a pinpoint manner, or an apparatus that ejects a liquid of transparent resin such as ultraviolet curing resin onto a substrate in order to form a minute hemispherical lens used for an optical communication element or the like, an optical lens, or the like. The liquid ejection apparatus may be an apparatus that ejects an etching liquid such as acid or alkali in order to etch a substrate or the like.

### Definition

The expression “at least one” used in this specification means “one or more” of desired alternatives. For example, the expression “at least one” used in the present specification means “either one of alternatives” or “both of two alternatives” when the number of the alternatives is two. As another example, the expression “at least one” used in the present specification means “just one alternative”, “a combination of any two alternatives”, or “a combination of any three or more alternatives” when the number of alternatives is three or more.

### APPENDICES

Technical ideas figured out from the embodiment and the modified examples described above, and functions and advantages thereof will hereinafter be described.
(A) A liquid ejection apparatus includes: a liquid ejection unit configured to eject a liquid; a circulation flow path configured to supply the liquid to the liquid ejection unit and recover the liquid from the liquid ejection unit; a pressure change mechanism configured to change pressure of the liquid in the circulation flow path; a first pressure control valve disposed upstream of the liquid ejection unit in the circulation flow path and configured to adjust pressure of the liquid flowing into the liquid ejection unit; and a second pressure control valve disposed downstream of the liquid ejection unit in the circulation flow path and configured to adjust pressure of the liquid flowing out from the liquid ejection unit, wherein the circulation flow path includes a main flow path in which the first pressure control valve and the second pressure control valve are disposed, and a bypass flow path branched from the main flow path.

According to this configuration, the circulation flow path includes the main flow path and the bypass flow path. The first pressure control valve and the second pressure control valve are disposed in the main flow path, but are not disposed in the bypass flow path. Therefore, by selectively using the bypass flow path and the main flow path, the pressure and the flow rate of the liquid supplied to the liquid ejection unit can be changed.
(B) In the liquid ejection apparatus described in (A), the main flow path may include a supply flow path configured to supply the liquid to the liquid ejection unit, and a recovery flow path configured to recover the liquid from the liquid ejection unit, and the bypass flow path may include a first bypass flow path in which a first upstream end is located upstream of the first pressure control valve and a first downstream end is located downstream of the first pressure control valve, and a second bypass flow path in which a second upstream end is located upstream of the second pressure control valve and a second downstream end is located downstream of the second pressure control valve.

According to this configuration, the first bypass flow path couples upstream and downstream of the first pressure control valve to each other. By using the first bypass flow path, it is possible to make the liquid flow without passing through the first pressure control valve. The second bypass flow path couples upstream and downstream of the second pressure control valve to each other. By using the second bypass flow path, it is possible to make the liquid flow without passing through the second pressure control valve. Therefore, since the liquid can be circulated at a high flow rate by using the first bypass flow path and the second bypass flow path, it is possible to make it easy to discharge the air bubbles.
(C) In the liquid ejection apparatus described in (A), the main flow path may include a supply flow path configured to supply the liquid to the liquid ejection unit, and a recovery flow path configured to recover the liquid from the liquid ejection unit, the bypass flow path may include a first bypass flow path in which a first upstream end is located in the supply flow path and a first downstream end is located in the recovery flow path, and a second bypass flow path in which a second upstream end is located in the supply flow path and a second downstream end is located in the recovery flow path, and the liquid ejection unit may be located between the first downstream end and the second upstream end.

According to this configuration, the liquid ejection unit is located between the first downstream end located in the recovery flow path and the second upstream end located in the supply flow path. Therefore, the direction in which liquid flows through the main flow path to the liquid ejection unit and the direction in which the liquid flows through the bypass flow path to the liquid ejection unit are opposite to each other. By reversing the flow direction of the liquid, it is possible to discharge air bubbles and stir the liquid.
(D) In the liquid ejection apparatus described in (C), the first upstream end may be located downstream of the first pressure control valve, the first downstream end may be located upstream of the second pressure control valve, the second upstream end may be located downstream of the first pressure control valve, and the second downstream end may be located upstream of the second pressure control valve.

According to this configuration, the first downstream end is located upstream of the second pressure control valve. The second upstream end is located downstream of the first pressure control valve. Therefore, the liquid passing through the first bypass flow path can be made to flow to the second bypass flow path via the liquid ejection unit.
(E) In the liquid ejection apparatus described in (C), the first upstream end may be located upstream of the first pressure control valve, the first downstream end may be located upstream of the second pressure control valve, the second upstream end may be located downstream of the first pressure control valve, and the second downstream end may be located downstream of the second pressure control valve.

According to this configuration, the first upstream end is located upstream of the first pressure control valve. The second downstream end is located downstream of the second pressure control valve. Therefore, by using the first bypass flow path and the second bypass flow path, it is possible to make the liquid flow without passing through the first pressure control valve and the second pressure control valve.
(F) In the liquid ejection apparatus described in (A), the liquid ejection unit may include a filter configured to filter the liquid, and a filter chamber in which the filter is disposed, the filter may be configured to partition the filter chamber into a filter anterior chamber and a filter posterior chamber, an upstream end of the bypass flow path may be located in the filter anterior chamber, and a downstream end of the bypass flow path may be located downstream of the filter posterior chamber.

According to this configuration, the upstream end of the bypass flow path is located in the filter anterior chamber. Therefore, it is possible to make it easy to discharge foreign matters such as air bubbles captured by the filter through the bypass flow path.
(G) In the liquid ejection apparatus described in (F), the downstream end may be located upstream of the second pressure control valve.

According to this configuration, the downstream end of the bypass flow path is located upstream of the second pressure control valve. Therefore, even when making the liquid flow through the bypass flow path, the fluctuation of the pressure of the liquid supplied to the liquid ejection unit can be reduced.
(H) In the liquid ejection apparatus described in (F), the downstream end may be located downstream of the second pressure control valve.

According to this configuration, the downstream end of the bypass flow path is located downstream of the second pressure control valve. Since the liquid can flow at a high flow rate without passing through the second pressure control valve, it is possible to make it easy to discharge the air bubbles.
(I) In the liquid ejection apparatus described in (F) to (H), when defining the bypass flow path as a first bypass flow path, the upstream end as a first upstream end, and the downstream end as a first downstream end, the liquid ejection apparatus may further include a second bypass flow path in which a second upstream end is located upstream of the first pressure control valve, and a second downstream end is located in the filter anterior chamber.

According to this configuration, the second bypass flow path couples upstream of the first pressure control valve and the filter anterior chamber to each other. By using the second bypass flow path, the liquid can be supplied to the filter anterior chamber without passing through the first pressure control valve.
(J) In the liquid ejection apparatus described in (A) to (I), there may further be included: a liquid storage unit coupled to the main flow path, wherein the pressure change mechanism may include a first liquid pump disposed upstream of the first pressure control valve in the main flow path, and a second liquid pump disposed downstream of the second pressure control valve in the main flow path.

According to this configuration, the liquid storage unit is coupled to the main flow path. Since the circulation flow path can be formed with respect to one liquid storage unit, the liquid ejection apparatus can be reduced in size compared to when the circulation flow path is formed with respect to a plurality of liquid storage units.
(K) In the liquid ejection apparatus described in (A) to (I), there may further included: a first liquid storage unit coupled to an upstream end of the main flow path; a second liquid storage unit coupled to a downstream end of the main flow path; a return flow path configured to couple the first liquid storage unit and the second liquid storage unit; and a liquid pump disposed in the return flow path, wherein the pressure change mechanism may include a pressure pump configured to pressurize an inside of the first liquid storage unit, and a pressure reducing pump configured to reduce pressure in the second liquid storage unit.

For example, when liquid is supplied by a diaphragm pump, pulsation occurs. In this regard, according to this configuration, the pressure pump pressurizes the inside of the first liquid storage unit. The pressure reducing pump reduces the pressure in the second liquid storage unit. The liquid can be stably circulated by applying pressure respectively to the liquid stored in the first liquid storage unit and the liquid stored in the second liquid storage unit.
(L) In the liquid ejection apparatus described in (A) to (K), the first pressure control valve may include a first upstream chamber into which the liquid flows via a first inflow port, a first downstream chamber that has a first flexible film and communicates with the first upstream chamber via a first communication opening downstream of the first upstream chamber, a second flexible film configured to separate the first upstream chamber from the first downstream chamber, a first opening and closing part configured to open and close the first communication opening, and a first biasing part configured to bias the first flexible film, and the first opening and closing part may be disposed over the first upstream chamber and the first downstream chamber, and may open and close the first communication opening by moving so as to follow a displacement of the first flexible film and the second flexible film.

According to this configuration, in the first pressure control valve, the first opening and closing part opens in accordance with the pressure in the first downstream chamber. Therefore, even when the pressure in the first upstream chamber fluctuates, the pressure in the first downstream chamber is adjusted to the preset pressure. Therefore, it is possible to shorten the time required for switching from the state in which the liquid flows through the main flow path to the state in which the liquid flows through the bypass flow path.
(M) In the liquid ejection apparatus described in (A) to (L), the second pressure control valve may include a second upstream chamber which includes a third flexible film and into which the liquid flows via a second inflow port, a second downstream chamber that communicates with the second upstream chamber via a second communication opening downstream of the second upstream chamber, a fourth flexible film configured to separate the second upstream chamber from the second downstream chamber, a second opening and closing part configured to open and close the second communication opening, and a second biasing part configured to bias the third flexible film in a direction of increasing a volume of the second downstream chamber, and the second opening and closing part may be disposed over the second upstream chamber and the second downstream chamber, and may open and close the second communication opening by moving so as to follow a displacement of the third flexible film and the fourth flexible film.

According to this configuration, in the second pressure control valve, the second opening and closing part opens in accordance with the pressure in the second downstream chamber. Therefore, even when the pressure in the second downstream chamber fluctuates, the pressure in the second upstream chamber is adjusted to the preset pressure. Therefore, it is possible to shorten the time required for switching from the state in which the liquid flows through the main flow path to the state in which the liquid flows through the bypass flow path.
(N) In the liquid ejection apparatus described in (L), the first biasing part may be configured to bias the first flexible film in a direction of decreasing a volume of the first downstream chamber.

According to this configuration, the direction in which the first biasing part biases the first flexible film is a direction of decreasing the volume of the first downstream chamber. Therefore, the pressure of the liquid which flows out can be adjusted to appropriate positive pressure.
(O) In the liquid ejection apparatus described in (L), the first biasing part may be configured to bias the first flexible film in a direction of increasing a volume of the first downstream chamber.

According to this configuration, the direction in which the first biasing part biases the first flexible film is a direction of increasing the volume of the first downstream chamber. Therefore, it is possible to adjust the pressure of the liquid which flows out to appropriate negative pressure.
(P) In the liquid ejection apparatus described in (A) to (O), there may further be included a moisturizing unit configured to keep humidify the liquid flowing through the circulation flow path with a moisturizing liquid, wherein the moisturizing unit may include a moisture permeable film configured to separate the liquid from the moisturizing liquid.

According to this configuration, the moisturizing unit keeps the humidity of the liquid which is circulating. Therefore, an increase in viscosity of the liquid can be suppressed.

What is claimed is:

1. A liquid ejection apparatus comprising:
a liquid ejection unit configured to eject a liquid;
a circulation flow path configured to supply the liquid to the liquid ejection unit and recover the liquid from the liquid ejection unit;
a pressure change mechanism configured to change pressure of the liquid in the circulation flow path;
a first pressure control valve disposed upstream of the liquid ejection unit in the circulation flow path and configured to adjust pressure of the liquid flowing into the liquid ejection unit; and
a second pressure control valve disposed downstream of the liquid ejection unit in the circulation flow path and configured to adjust pressure of the liquid flowing out from the liquid ejection unit, wherein
the circulation flow path includes
a main flow path in which the first pressure control valve and the second pressure control valve are disposed, and
a bypass flow path branched from the main flow path.

2. The liquid ejection apparatus according to claim 1, wherein
the main flow path includes
a supply flow path configured to supply the liquid to the liquid ejection unit, and
a recovery flow path configured to recover the liquid from the liquid ejection unit, and
the bypass flow path includes
a first bypass flow path in which a first upstream end is located upstream of the first pressure control valve and a first downstream end is located downstream of the first pressure control valve, and
a second bypass flow path in which a second upstream end is located upstream of the second pressure control valve and a second downstream end is located downstream of the second pressure control valve.

3. The liquid ejection apparatus according to claim 1, wherein
the main flow path includes
a supply flow path configured to supply the liquid to the liquid ejection unit, and
a recovery flow path configured to recover the liquid from the liquid ejection unit,
the bypass flow path includes
a first bypass flow path in which a first upstream end is located in the supply flow path and a first downstream end is located in the recovery flow path, and
a second bypass flow path in which a second upstream end is located in the supply flow path and a second downstream end is located in the recovery flow path, and
the liquid ejection unit is located between the first downstream end and the second upstream end.

4. The liquid ejection apparatus according to claim 3, wherein
the first upstream end is located downstream of the first pressure control valve,
the first downstream end is located upstream of the second pressure control valve,
the second upstream end is located downstream of the first pressure control valve, and
the second downstream end is located upstream of the second pressure control valve.

5. The liquid ejection apparatus according to claim 3, wherein
the first upstream end is located upstream of the first pressure control valve,
the first downstream end is located upstream of the second pressure control valve,
the second upstream end is located downstream of the first pressure control valve, and
the second downstream end is located downstream of the second pressure control valve.

6. The liquid ejection apparatus according to claim 1, wherein
the liquid ejection unit includes
a filter configured to filter the liquid, and
a filter chamber in which the filter is disposed,
the filter is configured to partition the filter chamber into a filter anterior chamber and a filter posterior chamber,
an upstream end of the bypass flow path is located in the filter anterior chamber, and
a downstream end of the bypass flow path is located downstream of the filter posterior chamber.

7. The liquid ejection apparatus according to claim 6, wherein
the downstream end is located upstream of the second pressure control valve.

8. The liquid ejection apparatus according to claim 6, wherein
the downstream end is located downstream of the second pressure control valve.

9. The liquid ejection apparatus according to claim 6, wherein
when defining the bypass flow path as a first bypass flow path, the upstream end as a first upstream end, and the downstream end as a first downstream end,
the liquid ejection apparatus further comprises a second bypass flow path in which a second upstream end is located upstream of the first pressure control valve, and a second downstream end is located in the filter anterior chamber.

10. The liquid ejection apparatus according to claim 1, further comprising:
a liquid storage unit coupled to the main flow path, wherein
the pressure change mechanism includes
a first liquid pump disposed upstream of the first pressure control valve in the main flow path, and
a second liquid pump disposed downstream of the second pressure control valve in the main flow path.

11. The liquid ejection apparatus according to claim 1, further comprising:
a first liquid storage unit coupled to an upstream end of the main flow path;
a second liquid storage unit coupled to a downstream end of the main flow path;
a return flow path configured to couple the first liquid storage unit and the second liquid storage unit; and
a liquid pump disposed in the return flow path, wherein
the pressure change mechanism includes
a pressure pump configured to pressurize an inside of the first liquid storage unit, and
a pressure reducing pump configured to reduce pressure in the second liquid storage unit.

12. The liquid ejection apparatus according to claim 1, wherein
the first pressure control valve includes
a first upstream chamber into which the liquid flows via a first inflow port,
a first downstream chamber that has a first flexible film and communicates with the first upstream chamber via a first communication opening downstream of the first upstream chamber,
a second flexible film configured to separate the first upstream chamber from the first downstream chamber,
a first opening and closing part configured to open and close the first communication opening, and
a first biasing part configured to bias the first flexible film, and
the first opening and closing part is disposed over the first upstream chamber and the first downstream chamber, and is configured to open and close the first communication opening by moving so as to follow a displacement of the first flexible film and the second flexible film.

13. The liquid ejection apparatus according to claim 12, wherein
the second pressure control valve includes
a second upstream chamber which includes a third flexible film and into which the liquid flows via a second inflow port,
a second downstream chamber that communicates with the second upstream chamber via a second communication opening downstream of the second upstream chamber,
a fourth flexible film configured to separate the second upstream chamber from the second downstream chamber,
a second opening and closing part configured to open and close the second communication opening, and
a second biasing part configured to bias the third flexible film in a direction of increasing a volume of the second downstream chamber, and
the second opening and closing part is disposed over the second upstream chamber and the second downstream chamber, and is configured to open and close the second communication opening by moving so as to follow a displacement of the third flexible film and the fourth flexible film.

14. The liquid ejection apparatus according to claim 12, wherein
the first biasing part is configured to bias the first flexible film in a direction of decreasing a volume of the first downstream chamber.

15. The liquid ejection apparatus according to claim 12, wherein
the first biasing part is configured to bias the first flexible film in a direction of increasing a volume of the first downstream chamber.

16. The liquid ejection apparatus according to claim 1, further comprising:
a moisturizing unit configured to keep humidify the liquid flowing through the circulation flow path with a moisturizing liquid, wherein
the moisturizing unit includes a moisture permeable film configured to separate the liquid from the moisturizing liquid.
